(19) United States
(12) Patent Application Publication
(10) Pub. No.: US 2026/0289591 A1
(43) Pub. Date: Sep. 24, 2026

(54) SYSTEM

(71) Applicant: SoftBank Group Corp., Tokyo (JP)

(72) Inventor: Fumihiro KOIKE, Tokyo (JP)

(73) Assignee: SoftBank Group Corp., Tokyo (JP)

(21) Appl. No.: 19/567,305

(22) Filed: Mar. 16, 2026

(30) Foreign Application Priority Data
Mar. 19, 2025 (JP) 2025-045164

(51) Int. Cl. G06Q 30/0201; G06N 20/00; H04L 51/02

(52) U.S. Cl. CPC G06Q 30/02011; G06N 20/00; H04L 51/02

(57) ABSTRACT

A system includes a processor that is configured to collect and analyze search data from an Internet search tool in order to determine, for a specified period, keywords by which a company of a user and a competitor company are searched, input, into a generative artificial intelligence model, a prompt that instructs generation of a summary of information automatically collected from information published by the competitor company, and receive an output summary from the generative artificial intelligence model, and visually display the generated summary so that a user can easily review the generated summary.

### CROSS-REFERENCE TO RELATED APPLICATION

This application is based on and claims priority under 35 USC 119 from Japanese Patent Application No. 2025-045164 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional competitive intelligence and market analysis systems primarily rely on static reports or simple dashboards based on search statistics or manually collected news. Such systems do not automatically combine (i) large-scale search data from Internet search tools, (ii) automatically collected and summarized information about competitors, and (iii) user-specific context such as the emotional state of the user. As a result, users are required to manually gather competitor press releases or public information, interpret such information without the aid of automated summarization, and then correlate it with search data. This manual work is time-consuming and prone to omissions and subjective bias. Furthermore, conventional systems do not dynamically adjust the presentation or emphasis of analytical results based on the emotional state or cognitive load of the user, which can lead to information overload or misinterpretation. Accordingly, there is a need for a system that automatically integrates search data analysis with generative artificial intelligence summarization of competitor information and that adapts the presentation of results based on recognition of the user's emotional state, thereby enabling the user to quickly and accurately grasp market and competitive trends.

### SUMMARY

In order to solve the above-described problems, according to one aspect of the invention, there is provided a system comprising a processor. The processor is configured to collect and analyze search data from an Internet search tool in order to determine, for a specified period, keywords by which a company of a user and a competitor company are searched. The processor is further configured to input, into a generative artificial intelligence model, a prompt that instructs generation of a summary of information automatically collected from information published by the competitor company, to receive an output summary from the generative artificial intelligence model, and to visually display the generated summary so that the user can easily review the generated summary. In addition, the processor is configured to analyze input data or behavior data of the user to recognize an emotional state of the user, to adjust an analysis result of the search data based on the emotional state, and to transmit adjusted information to a display device and cause the adjusted information to be displayed. By such configuration, the system automatically combines search behavior analysis and AI-based summarization of competitor information, and further tailors the displayed results to the user's emotional state, thereby reducing manual workload, preventing information overload, and enabling more accurate and timely decision-making.

The term “system” refers to an apparatus or combination of hardware and software components that performs one or more functions as described in the present specification and claims.

The term “processor” refers to one or more hardware processing units, such as a central processing unit (CPU), a graphics processing unit (GPU), a digital signal processor (DSP), or any other circuitry capable of executing instructions to perform the functions described in the present specification and claims, and may include a single device or a plurality of distributed devices.

The term “Internet search tool” refers to a service, engine, or platform accessible via a network, such as the Internet, that receives search queries from users or automated systems and returns search results or search-related data, including at least search keywords and information indicating frequency, volume, or trend of such keywords.

The term “search data” refers to data obtained from an Internet search tool that represents information related to search activities, including but not limited to search queries, search keywords, timestamps, regions, or aggregated metrics such as search volume or trend indices.

The term “specified period” refers to a time interval that is defined explicitly or implicitly by a user or by the system, and that serves as a basis for collecting, aggregating, or analyzing search data or other time-dependent information.

The term “company of a user” refers to an entity, such as a corporation, organization, or business, with which the user is affiliated, employed, or for which the user performs analysis using the system.

The term “competitor company” refers to an entity that provides products or services that compete, at least in part, with products or services of the company of the user, and whose public information is to be analyzed by the system.

The term “keywords” refers to one or more words, phrases, or character strings used as search terms in an Internet search tool and used by the system as units for collecting, aggregating, or analyzing search data.

The term “information published by the competitor company” refers to information that is made publicly available by or on behalf of the competitor company, including but not limited to press releases, announcements, product information pages, news articles, or postings on publicly accessible websites.

The term “generative artificial intelligence model” refers to a machine learning model, such as a large language model, transformer model, or other generative model, that is configured to generate text or other content in response to input data including prompts.

The term “prompt” refers to input data provided to the generative artificial intelligence model, including instructions, context, or example text, that causes the model to generate an output such as a summary according to the content of the input data.

The term “summary” refers to information generated by the generative artificial intelligence model that provides a condensed representation of one or more source texts, including essential points or key elements of the source texts, with shorter length than the source texts.

The term “visually display” refers to presenting information in a visual form on a display device, such as a monitor or screen, including presentation as text, graphics, charts, or other visual elements that can be perceived by a human user.

The term “input data of the user” refers to data that is explicitly entered or provided by the user to the system, including but not limited to text input, voice input, selections, or other interactive operations.

The term “behavior data of the user” refers to data that represents actions or interaction patterns of the user with respect to the system or related devices, including but not limited to operation logs, click patterns, viewing time, navigation history, or other observable behaviors.

The term “emotional state of the user” refers to a mental or affective state of the user, such as stress, interest, confusion, or satisfaction, that is inferred by the system based on analysis of the input data or behavior data of the user.

The term “analysis result of the search data” refers to information generated by the processor by processing and evaluating the search data, including but not limited to metrics, rankings, trends, correlations, visualizations, or other derived indicators related to the search data.

The term “adjust” refers to modifying, weighting, filtering, reordering, or otherwise changing the analysis result of the search data or other information based on one or more conditions, such as the emotional state of the user.

The term “adjusted information” refers to information that has been modified by the processor as a result of adjustment based on the emotional state of the user or other criteria, including adjusted analysis results, reformatted summaries, or prioritized items.

The term “display device” refers to any device capable of visually presenting information to a user, including but not limited to a computer monitor, smartphone display, tablet display, head-mounted display, or other screen-based or projection-based device.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

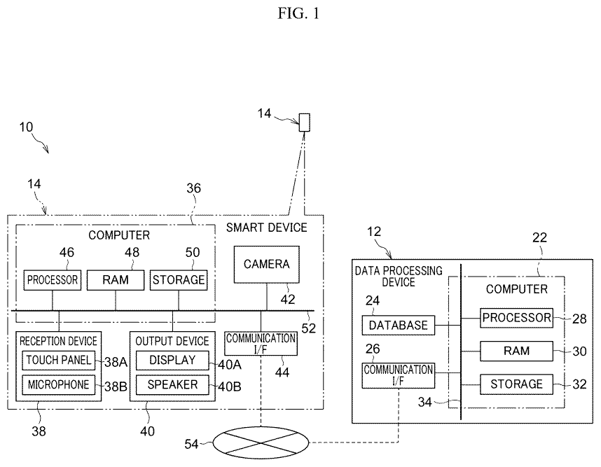

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

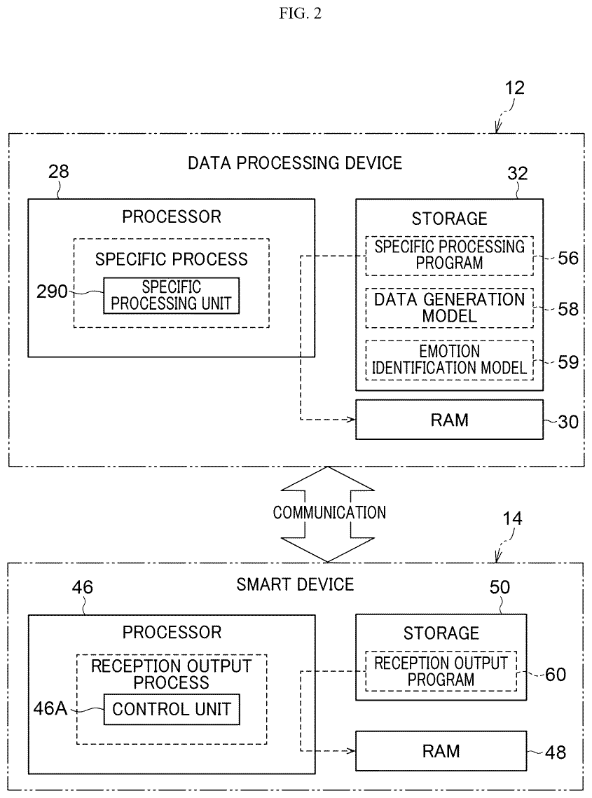

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional systems that analyze search data for brands or other entities generally focus on static aggregation and visualization of search volumes over time. Such systems typically retrieve search data from an external service, perform basic aggregation, and output fixed charts or reports. However, these systems suffer from several technical limitations in terms of computer technology and human-computer interaction.

First, conventional architectures do not effectively structure heterogeneous search data, which may include multiple time resolutions, regions, and search terms, into a unified tabular representation optimized for further machine processing. As a result, the processing logic for computing comparative indices, such as relative search ratios or trend transitions between multiple search terms, becomes fragmented and inefficient, leading to increased processing overhead and difficulty in scaling to larger data volumes or more complex comparison scenarios.

Second, conventional systems generally generate human-readable explanations either manually or through simple template-based text generation. These approaches are not integrated into the computational pipeline that produces analytical indices and visualizations. This lack of integration prevents the system from adaptively generating explanation text that is aligned with the computed indices and visualization data, and it forces users to interpret complex charts without machine-assisted narrative support, which can increase cognitive load and reduce usability.

Third, existing systems typically do not dynamically adapt either the analysis output or the narrative explanation to the state of the user as inferred from user interaction patterns. Even when user behavior data is collected, it is rarely used to control upstream components such as data acquisition, analysis regeneration, or prompt generation for a generative model. Consequently, the presentation remains static and one-size-fits-all, causing inefficiencies in how users interact with and extract insights from large, multi-dimensional search datasets.

Fourth, there is insufficient technical coordination between data analysis components, visualization components, and generative models. In particular, prompt sentences to generative models are often crafted in an ad hoc fashion and are not systematically derived from structured analysis results such as indices, comparative metrics, and trend features. This results in explanation texts that may not be tightly coupled to the underlying data representations used by the system, limiting reproducibility and the ability to tune the system's overall behavior.

Accordingly, there is a need for a computer-implemented system and method that: (i) structurally transforms raw search data from an external information providing apparatus into a unified, index-rich representation; (ii) generates visualization-ready data that supports interactive manipulation on a display apparatus; (iii) systematically produces prompt sentences for a generative AI model based on calculated indices and comparative results; and (iv) dynamically adjusts both the analysis pipeline and the generated explanation text according to an estimated user state derived from user input information and operation history. Such a system would improve the functioning of the computer by orchestrating data acquisition, analysis, visualization, and generative explanation in an integrated, feedback-driven processing pipeline.

The specific processing by the specific processing unit 290 of the data processing device 12 in Example 1 is realized by the following means.

The present invention provides a server comprising a processor configured to acquire, via a communication interface, information including search data from an information providing apparatus; to convert the acquired information into structured tabular data based on time information and area information; to calculate, from the structured tabular data, indices representing at least search frequency, relative search ratios, and trend transitions for a plurality of search terms; to convert comparative results of search trends relating to the plurality of search terms, based on the calculated indices, into visualization data and generate display control information for interactively displaying the visualization data on a display apparatus; to generate a prompt sentence including content summarizing analysis results containing the calculated indices and the comparative results, and instructions for a generation policy of an explanation; to input the prompt sentence into a generative information processing model and obtain, from the generative information processing model, an explanation text to be associated with the analysis results; to receive, from a user, input including search terms, period information, and area information, and additional conditions based on the user's viewing of the explanation text and the visualization data; to control, based on the additional conditions, re-acquisition of the information from the information providing apparatus and regeneration of the analysis results; to analyze user input information and operation history to estimate a state of the user; to adjust a presentation format of the analysis results by changing content of the prompt sentence and a level of detail or an expression format of the explanation text in accordance with the estimated state; and to transmit information including the explanation text, the visualization data, and screen configuration information reflecting the estimated state to the display apparatus so as to cause the display apparatus to emphasize or selectively display adjusted information. This enables an integrated, computer-implemented pipeline in which raw search data is transformed into index-rich analytical structures, interactively visualized, and coupled with dynamically generated explanation text that is adaptively tailored via prompt sentences to a generative AI model according to user state, thereby improving the computer's ability to provide efficient, user-adaptive search trend analysis and presentation.

The term “processor” refers to a hardware-based information processing element, such as a central processing unit or an execution core, that executes machine-readable instructions to perform data acquisition, data transformation, analysis, control, and communication operations as described in the present disclosure.

The term “communication function” refers to hardware and software components, including network interfaces and communication protocols, that enable the processor to exchange data with external apparatuses over a wired or wireless communication network.

The term “information providing apparatus” refers to an external computing resource, such as a network-accessible service or database, that supplies information including search data to the processor in response to a request transmitted via the communication function.

The term “search data” refers to information indicating usage of a retrieval service, including, for example, frequency or volume of search operations associated with one or more search terms over time and across regions.

The term “structured tabular data” refers to a data representation organized in a table-like form, such as rows and columns, in which each column corresponds to an attribute, including at least time information, area information, and one or more indices, and each row corresponds to a particular combination of attribute values.

The term “time information” refers to data indicating a temporal attribute of search data, including, for example, a date, time, time period, or a time interval associated with a search event or aggregated search volume.

The term “area information” refers to data indicating a spatial or regional attribute of search data, including, for example, a country, region, locality, or other geographic area associated with search activity.

The term “index” refers to a numerical or symbolic value derived from search data, including, for example, a search frequency, a relative search ratio, or a trend-related value, which is used to characterize and compare search behavior.

The term “search frequency” refers to an index indicating the number of search operations or an equivalent measure of search volume associated with a given search term within a specified time period and area.

The term “relative search ratio” refers to an index indicating a proportion or comparative measure of search frequency among a plurality of search terms, calculated from their respective search frequencies for a specified time period and area.

The term “trend transition” refers to a change or evolution in a value of an index, such as search frequency or relative search ratio, over time, including trend directions, growth or decline patterns, and temporal fluctuations.

The term “search term” refers to a character string or token set that is used as a query or keyword in a retrieval service and is associated with corresponding search data.

The term “comparative result” refers to information obtained by comparing indices associated with different search terms, time periods, or areas, and includes, for example, relative rankings, differences, ratios, and correlations.

The term “visualization data” refers to data structures that encode indices, comparative results, labels, and configuration information in a format suitable for graphical rendering on a display apparatus.

The term “display control information” refers to information specifying how visualization data is to be presented on a display apparatus, including, for example, chart types, axes, scales, colors, interaction behavior, and layout parameters.

The term “display apparatus” refers to a device or component that presents visual information to a user, such as a monitor, mobile device screen, or any graphical user interface display.

The term “prompt sentence” refers to a text string or other machine-readable instruction that includes at least a summary of analysis results and a generation policy for an explanation, and that is provided as input to a generative information processing model.

The term “generative information processing model” refers to a machine-learned model, such as a generative AI model, that receives a prompt sentence and generates corresponding output information, including natural language explanation text based on the prompt sentence.

The term “explanation text” refers to a natural language or structured text representation generated by the generative information processing model, which describes, interprets, or summarizes the analysis results derived from search data.

The term “user input information” refers to information explicitly provided by a user, including, for example, search terms, period information, area information, and additional conditions for analysis or visualization.

The term “operation history” refers to records of user actions performed through an interface, including, for example, selections, clicks, scrolling, zooming, and other interactions with visual or textual elements.

The term “user state” refers to an estimated condition or profile of a user, inferred from user input information and operation history, including, for example, a level of expertise, interest, attention, or comprehension.

The term “presentation format” refers to a manner in which analysis results, explanation text, and visualization data are provided to the user, including structural layout, level of detail, terminology, and emphasis.

The term “screen configuration information” refers to data defining arrangement and presentation of elements on a display screen, including locations, sizes, visibility, and highlighting of components such as charts, texts, and controls.

The term “additional condition” refers to a supplementary analysis or display requirement provided by the user after viewing the explanation text and the visualization data, including, for example, refined time periods, modified area selections, or additional search terms.

In one embodiment, a server executes a computer program that implements the claimed system on a general-purpose computing platform. The server includes at least one processor, a main memory, a nonvolatile storage device, a network interface, and a bus interconnecting these components. The server operates under control of an operating system such as a general-purpose server operating system and executes application software written in a high-level programming language such as a scripting language or an object-oriented language. The server uses software libraries for network communication, tabular data processing, numerical analysis, and graphical data serialization. The server communicates with an information providing apparatus via the network interface and communicates with one or more terminals over a packet-based network.

The terminal includes a processor, a memory, a display apparatus such as a flat-panel display, an input device such as a touchscreen or pointing device, and a network interface. The terminal executes a web browser or a dedicated application that can render graphical content and execute client-side scripts. The user operates the terminal, observes information presented on the display apparatus, and provides input and additional conditions through graphical user interface components.

The server converts heterogeneous search data into a unified, structured tabular format using a data frame structure in memory. The server stores each record of search data as a row containing at least time information, area information, a search term identifier, and one or more indices. The server represents time information using a standardized timestamp format and represents area information using normalized region identifiers. The server uses column-based indexing in the tabular structure to support efficient aggregation and comparison operations on the indices. By adopting this unified internal data representation, the server reduces the number of conversions between incompatible data formats, lowers memory fragmentation, and enables vectorized operations in the data processing library, thereby improving processing speed and scalability.

The server computes indices including search frequency, relative search ratios, and trend transitions using numerical operations that operate on entire columns of the tabular data. The server calculates search frequency by aggregating counts or normalized volume measures over specified time intervals and regions. The server calculates relative search ratios by dividing the search frequency of a given search term by a combined or reference frequency derived from multiple search terms. The server calculates trend transitions by applying difference operations, moving average filters, and rate-of-change calculations over sliding time windows. The server uses these algorithmic operations to reduce noise, identify sustained trends, and detect local maxima and minima in the indices. This enables the server to generate analysis results that are less sensitive to short-term fluctuations and more suitable for downstream interpretation and visualization.

The server generates visualization data that encodes the indices and comparative results in a format optimized for client-side graphical rendering. The server arranges time information as a sequence of labels and arranges corresponding index values as numerical sequences for each search term and region. The server generates configuration information specifying chart types, axis ranges, color assignments, and interaction options. The server assembles these elements into a compact data structure suitable for efficient transmission over the network. By precomputing axis limits, downsampling dense time series when appropriate, and combining related series into shared label arrays, the server reduces bandwidth usage, accelerates rendering on the terminal, and avoids redundant computation on the client side.

The server generates a prompt sentence to be input to a generative AI model based on the structured tabular data and the computed indices. The server extracts summary statistics, including averages, maxima, minima, and measures of variation, and determines salient features such as spikes, sustained growth periods, and relative ranking changes between search terms. The server converts these features into a textual summary segment and combines the summary with explicit instructions specifying the desired style, length, and target audience for the explanation. The server thereby constructs a prompt sentence that is systematically derived from machine-readable analysis results rather than being manually authored or arbitrarily fixed.

For example, the server may generate a prompt sentence such as:
“The server has analyzed search trend data for our brand ‘ABC’ and competitor ‘XYZ’ in Japan over the last 12 months. ABC shows an average search index of 70 with a major spike in March, while XYZ has an average of 85 with gradual growth from April to September. Regional data indicates ABC is strong in large metropolitan areas, while XYZ is growing in regional cities. Based on these results, describe the key differences in search trends, identify possible reasons for these patterns, and propose three actionable marketing strategies for brand ABC.”

In another example, the server may generate a prompt sentence such as:
“Using the following summary statistics: (1) ABC monthly search index: mean 70, max 120 in March, (2) XYZ monthly search index: mean 85, steady growth from April to September, (3) ABC's relative share declined from 60% to 45% over the year. Please write a concise, non-technical explanation for a marketing manager, highlighting risks and opportunities, and recommend concrete next steps.”

The server inputs the prompt sentence into a generative AI model implemented as a neural network. In one embodiment, the generative AI model is a sequence-to-sequence language model based on a transformer architecture with multiple self-attention layers, feedforward sublayers, and residual connections. The model includes an embedding layer that converts tokens of the prompt sentence into numerical vectors, a plurality of encoder-decoder blocks that propagate contextual information across positions in the sequence, and an output layer that maps hidden representations to probability distributions over a vocabulary. The model has been trained in advance on large corpora of text by minimizing a loss function such as cross-entropy between predicted tokens and ground-truth tokens. During training, the model updates weights using gradient-based optimization methods such as stochastic gradient descent or adaptive moment estimation. The training procedure may include regularization mechanisms such as dropout and layer normalization to improve generalization.

The server executes the generative AI model or invokes a remote service that executes such a model. The server supplies the prompt sentence, receives an output sequence of tokens from the model, and decodes the tokens into natural language explanation text. The server may constrain generation by specifying a maximum output length, a temperature parameter for sampling, or a top-k or nucleus sampling strategy to control diversity. The server uses explicit rules to ensure that the explanation text includes specific numeric values and comparisons that correspond to the structured tabular data, thereby avoiding misalignment between the explanation text and the underlying analysis. This rule-based post-processing is performed by checking whether key indices, such as maximum values and relative ratios, are correctly reflected in the generated text and, if necessary, regenerating or editing parts of the text under stricter constraints. This combination of numerical verification and controlled generation improves the reliability and reproducibility of the explanation text beyond simple human drafting or template filling.

The server estimates a state of the user by analyzing user input information and operation history. The server maintains, for each user session, a set of derived features such as the number of filters applied, the frequency of zooming into charts, the time spent hovering over tooltips, and changes in selected regions or search terms. The server applies a classification algorithm or regression algorithm to map these features to a user state representation. In one embodiment, the server uses a simple model such as a gradient-boosted decision tree classifier trained on labeled interaction data, where labels indicate categories such as “novice,” “intermediate,” or “expert” user. In another embodiment, the server uses a small neural network with an input layer receiving the interaction features, one or more hidden layers, and an output layer providing a continuous or discrete measure of user state. The server stores the resulting user state and uses it as a control parameter for subsequent processing steps.

The server adjusts the presentation format of the explanation text and visualization data based on the estimated user state. When the server detects a novice user state, the server selects a prompt construction policy that requests simpler language, fewer technical terms, and more high-level summaries. When the server detects an expert user state, the server selects a prompt construction policy that requests more granular quantitative details, references to specific indices, and direct discussion of statistical measures. The server thus modifies the prompt sentence content, including the requested level of detail and terminology, and obtains explanation text that is better aligned with the user's capability. The server additionally adjusts visualization settings such as default time range, density of tick marks, and whether to show advanced controls.

The terminal displays the visualization data and explanation text transmitted by the server. The terminal uses a client-side charting library to render line charts, bar charts, or other graphical elements on the display apparatus. The terminal obtains time labels and numerical sequences from the visualization data and plots them using hardware-accelerated drawing functions where available. The terminal responds to user interactions such as dragging, pinching, or clicking by highlighting specific data points, filtering series, or adjusting the displayed time range. The terminal sends updated interaction information to the server for use in refining the user state and regenerating explanations or visualizations as needed.

The user views the displayed charts and explanation text on the terminal and provides additional conditions via user interface elements. The user may specify new search terms, modify the time interval or area, or focus on specific segments of the chart. The user's operations are transmitted to the server as structured requests containing updated parameters. The server interprets these additional conditions and triggers new data acquisition, recomputation of indices, regeneration of visualization data, and regeneration of prompt sentences and explanation text. This creates a feedback loop in which the server continuously refines analysis and presentation in response to user-driven exploration.

The server improves computer technology in several ways. By enforcing a structured, index-centric tabular representation and using vectorized data processing for computing search frequency, relative search ratios, and trend transitions, the server reduces computational complexity compared to naïve record-by-record processing. The server's generation of visualization-ready data with precomputed axis limits, downsampled series, and combined label structures reduces the amount of data transmitted over the network and shortens rendering time on the terminal. The server's coordinated use of a generative AI model, prompt sentence construction rules, and numeric verification logic allows consistent, data-faithful generation of explanation text that would be difficult to achieve with manual or simple rule-based text generation alone. These improvements result in faster response times, reduced memory usage, improved accuracy of narrative explanations, and lower network load.

The server does not merely automate human analysis tasks but implements non-conventional, computer-specific processing flows. For example, the server uses user interaction features, which are not directly available to a human analyst observing a static chart, to infer user state and to adapt both analytical resolution and explanation style in real time. The server employs explicit algorithms to compute and validate indices, constructs prompts that encode these indices and constraints, and verifies that generated explanation text adheres to these constraints. These operations arise from internal data structures, algorithmic rules, and model configurations specific to computer execution, thereby yielding technical effects such as reduction in erroneous interpretations, improved throughput in processing large-scale search logs, and enhanced stability in a multi-user, networked environment.

In another embodiment, the server integrates a caching mechanism at the level of structured tabular data and precomputed indices. The server detects when newly requested analysis parameters overlap with prior requests and retrieves cached partial results rather than re-acquiring and reprocessing the entire dataset. The server merges cached and newly computed results using key-based joins on time and area attributes, thereby reducing redundant data acquisition and computation. This caching strategy directly decreases network load and CPU usage, contributing to improved scalability.

In yet another embodiment, the server executes the generative AI model locally using an optimized inference engine that exploits parallel execution on multiple cores or specialized accelerators. The server compresses the model weights using quantization while preserving sufficient accuracy for explanation generation, and the server loads only necessary model fragments into memory when constructing explanations. This configuration reduces inference latency and memory footprint, which is particularly beneficial when handling multiple simultaneous user sessions.

The server may employ alternative generative models and user state estimation mechanisms without departing from the core concept of constructing prompt sentences based on structured analytical indices and using the resulting explanation text in a feedback loop. For example, the server may use a recurrent neural network architecture with attention mechanisms instead of a transformer, or may interchange a rule-based classifier for the user state estimation model. The server may also incorporate additional indices, such as seasonality metrics or anomaly scores, computed using statistical algorithms or machine learning techniques, and inject these indices into the prompt sentence and visualization data.

The terminal may be realized as a desktop computer, a notebook computer, a tablet, or a smartphone, and may run a generic web browser or a dedicated native application. The server may support both push-based and pull-based communication with the terminal, allowing periodic updates of visualization data or on-demand regeneration in response to explicit user actions. The overall configuration is thus adaptable to various deployment environments while preserving the technical mechanisms that improve data processing efficiency, presentation adaptivity, and explanation fidelity.

Through these arrangements, the server, the terminal, and the user cooperate in a technically specific manner, with the server orchestrating data structuring, index computation, prompt-based generative explanation, and adaptive presentation control, the terminal executing graphical rendering and interaction capture, and the user steering the analysis through explicit and implicit inputs. The described embodiments enable practitioners to implement and operate the claimed system using commercially available computing hardware and software frameworks while achieving the stated technical effects.

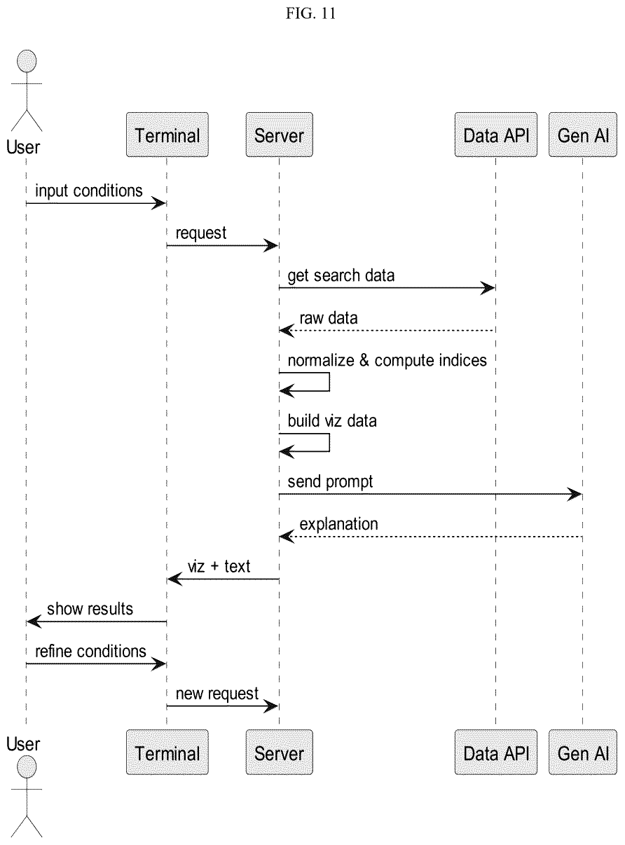

The following describes the processing flow using FIG. 11.

### Step 1

The user operates the terminal to provide initial analysis conditions.
The user inputs one or more search terms, a time period, and one or more areas through a graphical user interface on the terminal. The user may also select options such as the type of comparison (for example, brand versus competitor) and the desired level of detail. The terminal receives this input as structured data and transmits it to the server as a request.
Input: User-specified search terms, time period, areas, and option settings.
Output: A structured request message sent from the terminal to the server, containing the analysis conditions.

### Step 2

The server receives and validates the analysis request.
The server parses the structured request message and verifies that required fields such as search terms, time period, and areas are present and correctly formatted. The server checks that the requested time period is within supported bounds and that the area codes are known. If validation fails, the server generates an error response; otherwise, the server proceeds. The server logs the validated request for traceability.
Input: Structured request message from the terminal.
Output: A validated set of analysis parameters stored in server memory, or an error response returned to the terminal.

### Step 3

The server constructs queries for the information providing apparatus.
The server uses the validated analysis parameters to build one or more query parameter sets corresponding to combinations of search terms and areas. The server maps the requested time period into a format required by the information providing apparatus. The server then generates request messages suitable for a search-data service API.
Input: Validated analysis parameters (search terms, time period, areas).
Output: One or more API request objects, each including a search term, a time specification, and an area specification.

### Step 4

The server acquires raw search data from the information providing apparatus.
The server transmits the API request objects to the information providing apparatus via the network interface. The server waits for responses and receives raw search data, typically encoded as structured documents. The server decodes the documents into internal data structures, checks response status codes, and retries or logs failures if necessary.
Input: API request objects and response messages from the information providing apparatus.
Output: A collection of raw search data structures in server memory, each associated with a search term and an area.

### Step 5

The server normalizes and structures the raw search data into tabular form.
The server parses each raw data structure to extract time information, area information, and one or more search volume values. The server converts time information into standardized timestamps and maps area identifiers into a normalized set of region codes. The server inserts the extracted values into a tabular data structure, such as a table where each row represents a unique combination of time, area, and search term.
Input: Raw search data structures associated with search terms and areas.
Output: A unified tabular dataset containing columns for time, area, search term identifier, and basic search volume values.

### Step 6

The server computes indices including search frequency, relative search ratios, and trend transitions.
The server aggregates the tabular dataset over specified time intervals and areas to calculate search frequency indices for each search term. The server then derives relative search ratios by computing, for each time and area, the ratio of a search term's frequency to the combined frequency of multiple search terms. The server further computes trend transitions by applying difference operations, moving averages, and rate-of-change calculations along the time dimension. These operations are performed as column-wise computations on the tabular structure.
Input: Unified tabular dataset with basic search volume values.
Output: An enhanced tabular dataset augmented with computed indices for search frequency, relative search ratios, and trend transitions.

### Step 7:

The server extracts salient analytical features from the computed indices.
The server scans the enhanced dataset to identify notable events such as peaks, sustained increases, or decreases in search activity. The server applies threshold-based rules or statistical criteria to determine which points in time show significant deviations from typical levels. The server marks these points and aggregates them into a compact feature set summarizing key behaviors for each search term and area.
Input: Enhanced tabular dataset with computed indices.
Output: A feature summary including peak times, growth periods, declines, and relative changes between search terms.

### Step 8

The server generates visualization data and display control information.
The server transforms the enhanced dataset into arrays of time labels and index values organized by search term and area. The server selects appropriate chart types based on the number of search terms and indices to display, and then generates configuration parameters for axes, colors, legends, and interaction behaviors. The server optionally performs downsampling on dense time series to reduce data size while preserving visual fidelity.
Input: Enhanced tabular dataset and feature summary.
Output: Visualization data structures and display control information suitable for rendering interactive charts on the terminal.

### Step 9

The server constructs a prompt sentence for a generative AI model.
The server uses the feature summary and aggregated statistics to compose a textual description of the analysis results. The server selects key values such as average search indices, maximum peaks, periods of growth or decline, and notable relative changes. The server then appends instructions specifying the desired tone, length, and focus of the explanation. This combination forms a prompt sentence that reflects the computed indices and comparative results.
Input: Feature summary and aggregated statistics derived from the enhanced dataset.
Output: A prompt sentence constructed as a coherent text string suitable for input to a generative AI model.

### Step 10

The server obtains explanation text from the generative AI model.
The server supplies the prompt sentence to the generative AI model and requests generation of an explanation. The server receives a sequence of tokens representing the explanation text and decodes them into a natural language string. The server optionally performs consistency checks by comparing numeric statements in the generated text with the underlying indices, and if necessary, adjusts the prompt or regenerates sections to ensure alignment.
Input: Prompt sentence and generative AI model output tokens.
Output: An explanation text that describes and interprets the analysis results in natural language.

### Step 11

The server estimates a state of the user based on interaction data.
The server receives, from the terminal, records of the user's prior interactions, including filter selections, chart zoom operations, and time spent viewing certain views. The server converts these records into numeric features and inputs them to a user-state estimation model. The server obtains an estimated user state, such as a level of expertise or a preference profile.
Input: User interaction logs and user input history.
Output: An estimated user state represented as a set of parameters or labels.

### Step 12

The server adjusts the presentation format according to the estimated user state.
The server modifies parameters controlling the explanation text and visualization configuration. For a novice state, the server may reduce technical detail in the prompt sentence, request simpler language from the generative AI model, and hide advanced chart controls. For an expert state, the server may include more numerical detail in the prompt, request deeper analysis, and enable additional comparison views. The server regenerates or refines the prompt sentence and visualization data when necessary.
Input: Explanation text, visualization data, and estimated user state.
Output: Adapted explanation text and visualization configuration tuned to the user state.

### Step 13

The server assembles and transmits a response containing analysis results, visualization data, and explanation text.
The server packages the adapted explanation text, visualization data, and display control information into a response message. The server compresses the data if needed and sends the response to the terminal via the network. The server includes metadata indicating which user state assumptions were applied.
Input: Adapted explanation text, visualization data, and display control information.
Output: A response message delivered to the terminal, containing all information required for display.

### Step 14

The terminal renders interactive visualizations and displays the explanation text.
The terminal receives the response message, parses the visualization data and display control information, and initializes graphical components on the display apparatus. The terminal plots time-series lines, bars, or other graphical elements according to the provided configuration. The terminal presents the explanation text in a readable area adjacent to the visualizations and binds interaction handlers to chart elements so that user actions trigger highlighting or detailed tooltips.
Input: Response message from the server containing explanation text and visualization data.
Output: Rendered charts and explanation text displayed on the terminal, along with active interaction controls.

### Step 15

The user reviews the displayed information and provides additional conditions.
The user observes the charts and explanation text, identifies areas of interest, and manipulates filters, sliders, or selection controls on the terminal. The user may narrow the time period, focus on a subset of search terms, or add new search terms and areas. The user actions generate updated parameters that the terminal sends to the server as a new or modified analysis request.
Input: Visualized charts, explanation text, and interaction controls on the terminal.
Output: Updated analysis conditions transmitted from the terminal to the server, initiating another processing cycle based on refined requirements.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional digital advertising systems rely on static keyword lists and coarse analytics dashboards that are manually inspected by campaign operators. Such systems typically retrieve aggregated search statistics from external services and present them as charts or tables, but they do not algorithmically transform raw time-series search data into machine-interpretable trend structures that can be exploited in an automated way. As a result, the processor of such systems often performs generic data retrieval and simple aggregation without improving the functioning of the computer itself; it merely presents raw or minimally processed data to a human operator who must perform the substantive analysis.

Further, existing systems that incorporate generative models often use such models in an isolated fashion, for example by allowing a user to enter free-form prompts into a chat interface. In these configurations, the generative model operates without direct access to structured trend metrics computed from search history information, and the model output is typically free text that is not tightly integrated with the system's underlying data structures. Consequently, the processor is required to perform additional ad hoc parsing and manual mapping, or the user must copy and paste suggestions, which introduces latency, inconsistency, and error. This fragmented usage of generative models fails to provide a technical improvement in how the computer system represents, processes, and applies search data for advertising optimization.

Moreover, conventional user interfaces for campaign optimization do not adapt their content or ordering based on a dynamically estimated emotional state of the user. Presentation logic is usually fixed or based only on static user profiles, which means the system cannot optimize the sequencing and emphasis of complex analytical results to reduce cognitive load or guide user interaction more effectively. As a result, even when large volumes of data and advanced models are available, the interface layer may overwhelm the user, leading to suboptimal selection or configuration of advertising keywords. This limitation reflects an underutilization of the computer's capability to adjust internal presentation strategies based on real-time user state, and thus does not fully exploit the potential of the hardware and software resources. Accordingly, there is a need for a computer-implemented system in which the processor is specifically configured to: (i) transform raw search history information into structured trend information with time-series variation and growth metrics, (ii) automatically generate prompt sentences that embed this structured trend information as input to a generative AI model, (iii) receive and structurally parse response information from the generative AI model into intent-based groups of advertising search terms linked back to the underlying statistical information, and (iv) adapt the presentation of these results based on an estimated emotional state of the user. By architecting the processor and memory subsystems to perform these transformations and control flows, the system can improve the way the computer organizes, processes, and surfaces data for advertising keyword optimization, thereby enhancing the technical functioning of the overall computing environment.

The specific processing by the specific processing unit 290 of the data processing device 12 in Application Example 1 is realized by the following means.

The present invention provides a server comprising a processor configured to collect, store, aggregate, and statistically process search history information acquired from a search service via an information acquisition interface so as to generate, for each search term, trend information including at least a time-series variation amount and a growth rate; generate, based on the trend information and on stored advertising distribution conditions, a machine-readable input text including analysis results for optimization of candidate search terms for advertising distribution, and supply the input text as a prompt sentence to a generative information processing model executed locally or accessed via a communication interface; receive response information from the generative information processing model, the response information including groups of advertising search terms classified according to at least one of user attribute and user intent and explanation information corresponding to the groups; structurally parse the response information to extract individual advertising search terms and group labels, and associate each extracted advertising search term with corresponding statistical information derived from the search history information to generate evaluation information for each advertising search term; and control a presentation unit by transmitting the grouped advertising search terms and the evaluation information to a display control unit so as to cause an output device to display the grouped advertising search terms and the evaluation information in a selectable form that is directly applicable to an advertising distribution setting, and further configured to analyze user input information and operation history information to estimate an emotional state of a user and to adjust at least one of presentation content and presentation order of the displayed grouped advertising search terms and evaluation information in accordance with the estimated emotional state. This enables the computer system to perform a structured transformation of raw search data into trend-aware prompt sentences, to harness a generative AI model in a tightly integrated feedback loop, and to adaptively present model-driven keyword optimization results based on user state, thereby improving the technical functioning of the advertising optimization platform and reducing the cognitive and operational burden on the user.

The term “search history information” refers to data representing past search activities performed via one or more search services, including at least search terms, associated timestamps, and one or more metrics such as impression counts, click counts, or conversion counts.

The term “search service” refers to an information retrieval service implemented by one or more computing devices that receives a query from a user and returns search results, and that is capable of providing search-related data via a programmatic interface.

The term “information acquisition medium” refers to a hardware and software communication path, such as a network interface and associated communication protocol stack, through which the processor obtains search history information from an external search service.

The term “predetermined entity” refers to a target subject for which advertising or analysis is performed, such as a business, a product line, a service category, or a content provider.

The term “competing entity” refers to a subject that offers goods, services, or content that are regarded as alternatives or substitutes for offerings associated with the predetermined entity, and that is the subject of comparative search behavior.

The term “search term” refers to a character string, keyword, phrase, or combination of words that is included in a query submitted by a user to a search service.

The term “occurrence state of search terms” refers to a distribution or pattern indicating how frequently and under what conditions search terms appear in search history information over time, including absolute and relative frequencies.

The term “trend information” refers to data derived from search history information that characterizes temporal changes in one or more metrics for a given search term, including but not limited to time-series variation, growth rate, or directional trend labels.

The term “time-series variation amount” refers to a value or set of values indicating how a metric associated with a search term changes over successive time intervals, such as daily or weekly differences or moving averages.

The term “growth rate” refers to a metric indicating an increase or decrease in a value associated with a search term over a given time period, such as a ratio or percentage change between earlier and later portions of the time period.

The term “advertising distribution conditions” refers to configuration parameters used to control electronic advertisement placement, including at least target region, target audience, budget constraints, bidding strategies, and time schedules.

The term “candidate search terms for advertising distribution” refers to search terms that are considered as possible triggers or targeting keys for serving advertisements in an electronic advertising system.

The term “input text” refers to a sequence of characters or symbols generated by the processor and formatted as natural language or structured text, which encapsulates analytical results and contextual information for consumption by a generative information processing model.

The term “prompt sentence” refers to a form of input text provided to a generative information processing model, the input text including instructions, constraints, or contextual data that guide the behavior and output of the model.

The term “generative information processing model” refers to a machine-learned computational model configured to generate text or other data in response to input text, such as a neural network-based generative AI model trained on large-scale data.

The term “response information” refers to output data produced by the generative information processing model in response to a prompt sentence, including at least proposed advertising search terms and associated explanatory information.

The term “groups of advertising search terms” refers to sets of advertising-oriented search terms that are clustered or classified according to one or more criteria, such as user attribute, user intent, or functional role within an advertising campaign.

The term “user attribute” refers to a characteristic associated with a user or user segment, such as demographic category, geographic region, interest category, or device type, which can be used to differentiate advertisement targeting.

The term “user intent” refers to an inferred purpose or motivation underlying a user's search behavior, such as information gathering, comparison, purchase consideration, or problem resolution.

The term “explanation information” refers to descriptive text or structured data that indicates reasons, rationales, or contextual factors for grouping or recommending particular advertising search terms.

The term “statistical information based on the search history information” refers to numerical or categorical data derived from search history information, including aggregated counts, averages, variances, ratios, and other statistical measures associated with search terms.

The term “evaluation information for each advertising search term” refers to data that characterizes a predicted or measured suitability, effectiveness, or priority of an advertising search term, derived at least in part from statistical information and generative model output.

The term “display control unit” refers to a hardware and software component that receives presentation data from the processor and controls a display device to render graphical or textual information.

The term “output device” refers to a hardware component such as a display, monitor, or other visual output apparatus that presents information to a user under control of the display control unit.

The term “advertising distribution setting” refers to a configuration state of an advertising system, including at least selected keywords, targeting criteria, and budget allocations used to control advertisement delivery.

The term “user input information” refers to data explicitly provided by a user through input devices, such as typed text, pointer actions, selections, or other interaction signals.

The term “operation history information” refers to records of past user interactions with the system, including sequences of actions, timing of operations, and navigation patterns within a user interface.

The term “emotional state of the user” refers to an estimated affective condition of a user, such as stress, confusion, confidence, or engagement, inferred from user input information and operation history information.

The term “presentation content” refers to the information units selected for display to the user, including text, lists of search terms, graphs, indicators, and associated explanatory data.

The term “presentation order” refers to the sequence or layout arrangement in which presentation content is displayed to the user, such as ranking, grouping order, or page flow.

In one embodiment, a server, a terminal, and a user cooperate to implement the claimed system. The server includes at least one processor, a memory, a network interface, and a storage device. The processor may be a general-purpose central processing unit such as an x86_64 or ARM-compatible processor, and may be combined with an accelerator such as a graphics processing unit or tensor processing unit. The memory may include volatile memory such as dynamic random access memory, and the storage device may include non-volatile memory such as a solid-state drive or magnetic disk. The terminal may be a mobile communication device, a tablet device, or a personal computer, and includes a display unit, an input unit, and a network communication unit. The user operates the terminal to interact with the server.

The server executes an operating system such as a general-purpose server operating system and application software including a web application framework and data analysis libraries. In one example, the server executes a software stack including a Linux-based operating system, a web framework such as a Python-based web framework, data analysis libraries such as a numerical computation library and a data frame library, and a machine learning library such as a deep learning framework. The server uses a database management system such as a relational database system to store search history information, trend information, and advertising search term proposals.

The server acquires search history information from a search service via a network interface functioning as an information acquisition medium. The search history information includes a set of records, each record including at least a search term, a timestamp indicating when the search was performed, and one or more metrics such as a number of impressions, a number of clicks, a click-through rate, or a conversion count. The search service may provide this information via a programmatic interface such as an application programming interface exposed over a network.

The server stores the acquired search history information in a normalized data structure in the database. For example, the server stores the information in tables keyed by a session identifier, a date, and a search term, with additional fields for metrics and source identifiers. The server uses the data frame library to load the information from the database into in-memory columnar data structures, which enables efficient vectorized operations over large sets of search records.

The server processes the search history information to generate trend information for each search term. The server performs operations including aggregation of metric values over discrete time intervals, calculation of time-series variation amounts by differencing aggregated values between successive intervals, and computation of growth rates by comparing aggregated values between earlier and later sub-periods of a given analysis period. The server may also compute moving averages, standard deviations, and other statistical measures for each search term.

The server represents the trend information in a data structure indexed by search term, where each entry includes values for one or more metrics such as total search volume, average daily volume, growth rate, volatility, and a trend label. The server may assign the trend label, for example, as one of “rising,” “stable,” or “declining,” based on threshold rules applied to the growth rate and variation metrics. By using explicit numerical thresholds and deterministic mapping from metrics to labels, the processor performs a technical classification that can be efficiently repeated and scaled.

The server further stores advertising distribution conditions in the database. These conditions include structures specifying target regions, target user attributes, budget constraints, and advertising objectives. The server links the trend information and the advertising distribution conditions in memory, forming a structured representation that describes the context in which advertising search terms are to be optimized.

The server generates an input text used as a prompt sentence for a generative AI model. The server constructs this prompt sentence according to a predefined template that includes sections for campaign context, trend metrics, and explicit instructions. The server converts selected elements of the trend information—such as search terms, total search counts, and growth rates—into text fragments. The server inserts these fragments into the template in a controlled format to ensure that the resulting prompt sentence contains a consistent structure that the generative AI model can exploit. In contrast to a human-typed, ad hoc query, this programmatic generation uses transformation rules that depend on thresholded metrics, sorting by growth rate, and grouping by inferred user intent, thereby encoding non-trivial algorithmic preprocessing of the data.

For example, the server may generate a prompt sentence such as:
“You are a marketing assistant.
We are optimizing an advertising campaign for a target product by a target entity.
The objective is to maximize clicks and conversions among target users in a specified region who are researching or comparing this product.
Here is the recent keyword trend data (period: 2026-01-01 to 2026-01-31):
‘keyword 1’: total_searches=10000, growth_rate=0.05, trend=rising
‘keyword 2’: total_searches=4000, growth_rate=0.40, trend=strongly_rising
‘keyword 3’: total_searches=3200, growth_rate=0.25, trend=rising
‘keyword 4’: total_searches=2500, growth_rate=0.30, trend=rising
‘keyword 5’: total_searches=3800, growth_rate=0.10, trend=slightly_rising
Please analyze these trends and propose a list of optimized advertising keywords in a specified language that can effectively reach target users.
Group the keywords by user intent (review, comparison, price, feature, problem/concern).
For each group, briefly explain why the keywords are likely to perform well based on the trend data.”

In another example, the server may generate a more concise prompt sentence such as:
“To optimize an advertising campaign for a specified product, analyze the trends of related search keywords and propose the most effective advertising keywords. Assume that you have access to search volume and growth rates from multiple search services. Focus on keywords that indicate strong purchase intent or product comparison intent.”

In yet another variation, the server may include explicit ranking requirements and output format constraints in the prompt sentence, such as:
“Given recent search trends for a target product and a competing product, suggest 20 high-impact advertising keywords for an online advertising campaign targeting users in a specified region. Include a mix of review, feature, comparison, and price-focused keywords, and rank them by expected effectiveness. Output the result as grouped lists, where each group corresponds to one user intent category.”

The server provides the prompt sentence to a generative AI model that is implemented as a generative information processing model. In one embodiment, the generative AI model is a neural network-based language model with a transformer architecture, including a stack of self-attention layers, feed-forward layers, and layer normalization components. The model parameters include, for example, several hundred million to several billion trainable weights. The model has been pre-trained on a large corpus of text data and optionally fine-tuned on domain-specific data including advertising-related text.

The server communicates with the generative AI model via a model execution engine implemented using a deep learning framework. The server may host the model locally on a graphics processing unit or tensor processing unit, or may access the model via a remote inference service. In either case, the server converts the prompt sentence into token indices via a tokenizer, supplies the token sequence to the model, and controls generation parameters such as sampling temperature, maximum output length, and decoding strategy (for example, greedy decoding or beam search). The server thus deterministically controls the operation of the generative AI model to produce response information.

Internally, the generative AI model computes, for each decoding step, token-level probability distributions based on the current hidden state and the learned attention weights, and selects the next token according to the chosen decoding strategy. The model's behavior is therefore a function of both the prompt sentence and the learned parameters, which encapsulate patterns not explicitly codified by human rules. This enables the model to identify nuanced relationships between trend metrics and semantic content of search terms that a rule-based system would have difficulty capturing.

The server receives the response information from the generative AI model as a sequence of tokens, which is decoded into natural language text. The response information typically includes multiple groups of advertising search terms, each labeled by an intent category such as review, comparison, price, feature, or problem, along with explanatory text for why each group is relevant.

The server then applies a parsing procedure to the response information. The server uses pattern recognition rules, such as detecting group headings, list markers, and line breaks, to segment the text into group labels and individual search term candidates. The server may also employ a secondary classifier model, such as a smaller neural network or a rule-based tagger, to validate and normalize intent labels. The server converts the segmented information into a structured representation stored in memory, such as a nested dictionary or an equivalent data structure, and writes corresponding records into a database table for persistent storage.

The server further associates each advertising search term candidate with statistical information derived from the original search history information. The server queries the database for matching or similar search terms and retrieves metrics such as historical search volume, click-through rate, and growth rate. If an exact match is found, the server links the candidate term to the corresponding metrics. If only partial matches or closely related variants exist, the server may compute a similarity measure using, for example, a text similarity algorithm, and associate the candidate term with the closest matching metrics above a similarity threshold.

The server then generates evaluation information for each advertising search term. The evaluation information may include a score computed as a weighted combination of metrics and model-derived factors. For instance, the server may compute an evaluation score as a function of growth rate, base volume, intent category, and frequency of appearance in the generative model's output. By formalizing this evaluation as a deterministic mathematical function and storing the results in structured fields, the server converts qualitative model output into quantitative, machine-usable values.

The server transmits the grouped advertising search terms and the associated evaluation information to a display control unit implemented as part of the terminal or as a module within the server that outputs rendering instructions to the terminal. The server structures the transmitted data so that the terminal can render interactive interfaces allowing the user to sort, filter, and select advertising search terms. The server may include layout metadata specifying default presentation order, group expansion states, and emphasis indicators based on evaluation scores.

The terminal receives this information via a network communication unit and renders it on the display unit using user-interface components. The terminal displays, for example, a list of intent-based groups, each containing advertising search terms accompanied by evaluation scores and trend labels. The user can select or deselect terms through the input unit, and can request additional details such as historical graphs or explanation text.

The server also analyzes user input information and operation history information to estimate an emotional state of the user. The server observes features such as input speed, frequency of switching between screens, number of times help information is requested, and patterns of cursor or touch movements. The server may apply a classifier, for example a shallow neural network or a support vector machine trained on labeled interaction data, to map these features to emotional state categories such as high load, confusion, or confidence.

Based on the estimated emotional state, the server adjusts presentation content and presentation order. For instance, when the server detects that the user is likely in a high cognitive load state, the server may reduce the number of visible groups, highlight the highest evaluation-score terms, and defer display of more detailed statistical data. By contrast, when the server detects that the user is in a confident or exploratory state, the server may display more granular information and advanced options. The server encodes these adjustments as changes to layout metadata transmitted to the terminal, so that the terminal can reconfigure the user interface in real time.

This combination of algorithmic preprocessing of search history information, structured prompt sentence generation, generative AI model integration, structured parsing of model output, quantitative evaluation of advertising search terms, and adaptive user interface control yields technical effects beyond mere automation of human judgment. By using vectorized numerical libraries and optimized database queries, the server reduces computational redundancy and improves processing speed, enabling analysis of large volumes of search data within practical time frames. By structuring the prompt sentence with embedded trend metrics and constraints, the server drives the generative AI model to produce output that aligns closely with the underlying data, improving the accuracy and relevance of proposed advertising search terms compared to generic free-form interaction.

Furthermore, by automatically converting ambiguous natural language output into structured, machine-processable data linked to precise historical metrics, the server enhances data management and reduces the risk of human transcription errors. The adaptive presentation logic, driven by algorithmic estimation of the user's emotional state, reduces the likelihood that the user will misinterpret complex analytical results, thus lowering configuration mistakes in advertising distributions. The combination of these mechanisms improves the technical functioning of the computing system as a whole, in terms of processing efficiency, data coherence, robustness of the user interface, and the precision of keyword optimization results.

In alternative embodiments, the server may employ different types of generative AI models, such as encoder-decoder architectures or mixture-of-experts models, and may vary the tokenizer type, decoding strategy, and prompt templates. The server may also implement alternative similarity measures for linking generated advertising search terms with historical metrics, including character-level distance metrics or embedding-based similarity metrics computed by a separate neural network. The emotional state estimation component may be replaced or supplemented by rule-based heuristics derived from interface design studies, without departing from the scope of the system.

In another variation, the terminal may perform part of the presentation adaptation locally, using parameters supplied by the server. In this case, the server provides high-level configuration directives, and the terminal applies them to specific user-interface components. As long as the processor of the server remains configured to perform the transformations of search history information, generation of structured prompt sentences, control of the generative AI model, parsing and evaluation of model outputs, and coordination of presentation adjustments, the system continues to exhibit the described technical advantages.

Through these embodiments and variations, the server, the terminal, and the user cooperate in a system that improves the way computers collect, represent, and apply search history information for advertising optimization, by implementing specialized data structures, model integration techniques, and adaptive user interface control that are not conventionally available in generic analytics dashboards or manual campaign management tools.

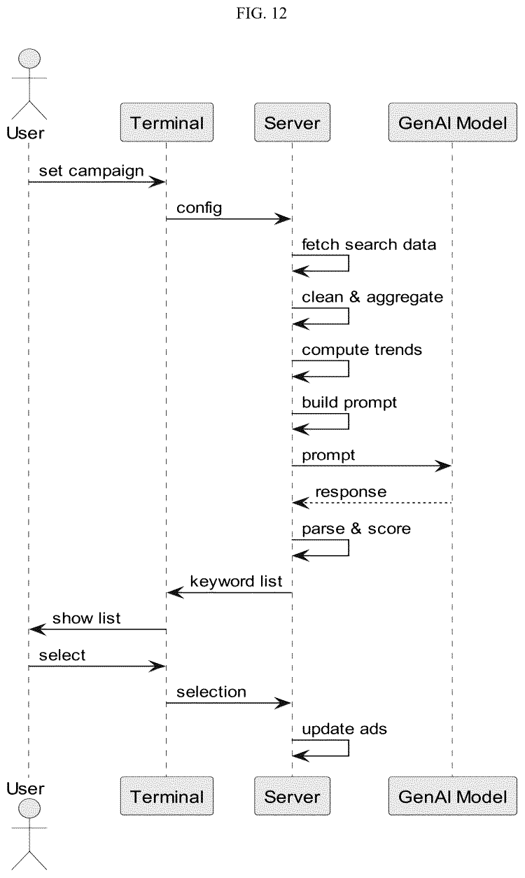

The following describes the processing flow using FIG. 12.

### Step 1

Server receives campaign configuration and analysis conditions from the terminal.
Server uses a network interface to accept an incoming message from the terminal that includes input values such as a target product description, a target entity identifier, one or more competitor identifiers, an analysis period, and one or more advertising objectives. Server parses the received message and validates the input format, for example checking that the start date precedes the end date and that required fields are present. Server then generates a session identifier and stores the raw configuration data in a configuration table in a storage device. The input of this step is a structured request from the terminal containing campaign configuration data, and the output is a validated and normalized internal representation of the campaign configuration stored in association with a session identifier.

### Step 2

Server acquires search history information from one or more search services.
Server uses the configuration data for the session as input, including the target entity, competing entities, and analysis period. Server constructs one or more programmatic requests to external search services, each request specifying query parameters such as a domain, a set of seed search terms, and a time range. Server transmits these requests via the network interface and receives response messages that contain raw search history information, such as search terms, timestamps, impression counts, and click counts. Server converts the response messages into a unified internal data structure, for example by mapping each field to a normalized schema, and stores the resulting records in a search history table keyed by the session identifier. The input of this step is the campaign configuration for the session, and the output is a set of normalized search history records stored in the database.

### Step 3

Server cleans and aggregates the search history information into time-series data structures.
Server reads the normalized search history records for the session from the storage device into memory. Server uses data analysis libraries to group the records by search term and by time interval, such as by day or by week. Server performs data cleaning operations including removal of empty search terms, trimming of whitespace, conversion to a consistent case, and optional filtering of noise terms. Server then aggregates numerical metrics, such as summing impressions and clicks per search term per interval. Server writes the aggregated and cleaned records to a trend-preparation table in the database. The input of this step is the raw normalized search history records associated with the session, and the output is a set of cleaned, time-indexed records for each search term that can be used for trend computation.

### Step 4

Server computes trend metrics and generates trend information for each search term.
Server loads the cleaned, time-indexed records for the session into in-memory arrays or data frames. Server calculates, for each search term, time-series variation amounts by subtracting metric values of consecutive intervals and computing moving averages, and computes growth rates by comparing metrics from an earlier sub-period of the analysis interval to a later sub-period. Server may also calculate other statistics, such as variance or standard deviation, and then applies threshold rules to assign a trend label such as “rising,” “stable,” or “declining” to each search term. Server stores the trend information in a trend table, where each record links a search term with its total volume, growth rate, and trend label. The input of this step is the cleaned, time-indexed search history data, and the output is structured trend information for each search term, including numerical metrics and categorical labels.

### Step 5

Server links trend information with advertising distribution conditions.
Server reads the trend information and the advertising distribution conditions for the session from the database. Server combines these two types of data in memory by associating each search term with relevant objectives, target regions, and target user attributes defined in the advertising distribution conditions. Server may rank search terms according to a composite metric that considers not only growth rate but also minimum base volume and alignment with target user attributes. Server creates an intermediate ranked list of candidate search terms for advertising, grouped by objective or by basic intent derived from keyword patterns. The input of this step is the trend information and advertising distribution conditions, and the output is a structured list or table of candidate advertising search terms associated with contextual campaign parameters.

### Step 6

Server generates a structured prompt sentence for a generative AI model.
Server uses the ranked candidate list and associated metrics as input. Server selects a subset of search terms, for example the top terms by growth rate or relevance, and converts each selected term and its metrics into a textual fragment following a predefined format, such as “term: total_searches=X, growth_rate=Y, trend=Z.” Server inserts these fragments, along with campaign context (product description, target region, objective) and explicit instructions, into a prompt template to create a complete prompt sentence. Server orders the fragments according to ranking criteria to control the emphasis seen by the generative AI model. The input of this step is the structured list of candidate search terms and campaign context, and the output is a single prompt sentence or a small set of prompt sentences encoded as textual strings ready for submission to the generative AI model.

### Step 7

Server submits the prompt sentence to a generative AI model and obtains response information.
Server takes the prompt sentence as input and passes it through a tokenizer to convert the text into a sequence of tokens according to the vocabulary of the generative AI model. Server invokes a model inference engine, such as a transformer-based neural network executed on a processing accelerator, and supplies the token sequence along with generation parameters such as maximum length and sampling strategy. Server causes the model to iteratively compute, for each decoding step, attention-weighted hidden states and probability distributions over the vocabulary, and then selects the next token in the sequence according to the chosen decoding algorithm. When the model reaches a termination condition, server collects the generated token sequence and converts it back to human-readable text. The input of this step is the constructed prompt sentence, and the output is response information in natural language text that proposes grouped advertising search terms and explanatory comments.

### Step 8

Server parses the response information into grouped advertising search terms.
Server receives the response text from the generative AI model and loads it into a text-processing module. Server applies parsing rules, such as detecting line prefixes, bullet markers, group headers, and delimiters, to segment the text into separate blocks representing group titles and individual search terms. Server may also apply a pattern-matching or classification module to normalize group names to standard intent categories such as review, comparison, price, feature, or problem. Server constructs a structured representation that consists of a list of groups, each group containing an intent label and multiple candidate advertising search terms. The input of this step is the raw response text from the generative AI model, and the output is a machine-readable, structured grouping of advertising search terms by intent category.

### Step 9

Server associates each advertising search term with historical statistics and generates evaluation information.
Server takes the grouped advertising search terms as input and iterates over each term. For each advertising search term, server queries the trend table and search history tables for records that match or closely resemble the term. If exact matches are found, server retrieves corresponding metrics such as total volume, growth rate, and click-through rate; if only similar terms exist, server may compute a similarity value using a text similarity algorithm and retrieve metrics only when the similarity exceeds a threshold. Server then computes evaluation information, such as a numerical score that is a weighted combination of metrics and group intent type, and attaches this evaluation data to each advertising search term record. Server writes the enriched records to an evaluation table in the database. The input of this step is the set of grouped advertising search terms, and the output is a set of advertising search term records each annotated with evaluation metrics and links to historical data.

### Step 10

Server prepares presentation data and transmits it to the terminal.
Server reads the evaluated advertising search term records for the session and constructs a presentation data structure that includes group labels, term texts, evaluation scores, trend labels, and any necessary display attributes such as highlighting flags. Server may sort the terms within each group according to evaluation score and may determine a default group order. Server then serializes this data structure into a message format suitable for transmission, and sends it to the terminal via the network interface. The input of this step is the evaluated advertising search term records, and the output is a formatted presentation payload transmitted to the terminal for rendering on a user interface.

### Step 11

Terminal renders the grouped advertising search terms and accepts user selections.
Terminal receives the presentation payload from the server and parses it into in-memory objects representing groups and terms. Terminal uses its display unit to render a user interface, such as a list view organized by intent groups, where each advertising search term is shown with its evaluation score and trend label. Terminal allows the user to interact with the interface through input devices by selecting or deselecting terms, expanding or collapsing groups, and requesting additional details for specific terms. The input of this step is the presentation payload received from the server, and the output is user selection data and interaction signals captured by the terminal.

### Step 12

Server estimates the emotional state of the user based on interaction patterns.
Server receives user interaction logs and selection data from the terminal as input, including information such as timestamps of operations, frequency of view changes, and usage of help features. Server extracts numerical features from these logs and applies a classifier model or rule set that maps feature patterns to an estimated emotional state, such as high cognitive load, confusion, or confidence. Server then determines whether the current presentation strategy should be adjusted based on the estimated state. The input of this step is the user interaction data collected by the terminal, and the output is an estimated emotional state and a decision regarding presentation adjustment.

### Step 13

Server adjusts presentation content and order, and updates the terminal display.
Server takes the estimated emotional state and the current presentation configuration as input. Server modifies layout parameters, such as the number of visible groups, the amount of detail shown per term, and the ranking criteria for displayed terms, in accordance with rules that link emotional state to interface complexity. For example, server may limit the display to top-ranked terms when a high load state is detected. Server packages the updated presentation parameters or a revised presentation payload and transmits it to the terminal. Terminal then re-renders the user interface according to the updated parameters. The input of this step is the estimated emotional state and existing presentation configuration, and the output is an adjusted presentation configuration that changes how the grouped advertising search terms and evaluation information are displayed to the user.

### Step 14

Server receives final user selections and updates advertising distribution settings.
Server obtains, from the terminal, the final set of advertising search terms selected by the user together with any specified advertising distribution preferences such as target platform or budget limits. Server merges this selection data with the existing campaign configuration for the session and updates an advertising distribution settings table in the database. Server may also optionally construct configuration messages suitable for external advertising platforms and store them for subsequent transmission. The input of this step is the user's final selection of advertising search terms and campaign preferences, and the output is an updated advertising distribution configuration stored in the system and ready for execution by external advertising systems.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional competitor-monitoring systems largely rely on manual collection and review of publicly available information, such as press releases and news articles, combined with separate analysis of search history information. In many deployments, networked computers simply retrieve raw documents from network locations and display them in unstructured form to human operators. As a result, the systems offload the essential tasks of selecting relevant sources, normalizing heterogeneous document structures, compressing long natural-language content into concise summaries, and correlating such summaries with search history information to the human user. This leads to significant latency, operator burden, and inconsistency in the way information is processed and presented.

Furthermore, in typical architectures, the processor merely executes generic web-crawling and reporting software that outputs unstructured or semi-structured logs or lists. These implementations do not provide a computer-centric mechanism for automatically transforming heterogeneous structured document data from multiple public information sources into standardized, machine-processable summary record data, nor do they provide an integrated pipeline in which prompt sentences for a generative artificial intelligence model are programmatically constructed, applied to preprocessed text data, and postprocessed into visualization data suitable for interactive display. As a consequence, the computing resources are used inefficiently, the storage subsystem is filled with redundant or excessively long documents, and the user interface layer must perform ad hoc processing to make the information usable.

Additionally, existing systems typically present the same static visualization to all users regardless of individual context or state. Processors in such systems do not treat user state information, such as an estimated emotional state derived from interaction patterns, as a signal for dynamically reconfiguring how summary record data is ordered, emphasized, or filtered. Because the visualization pipeline is not designed to react to user-specific or time-varying conditions, the human-machine interface cannot be optimized at the system level, leading to suboptimal information retrieval and decision support performance.

There is therefore a need for technical improvements in computer-implemented competitor-monitoring systems, in which a processor is specifically configured to (i) acquire search history information from a communication network and compute structured analysis results for specified and competing business entities, (ii) automatically obtain structured document data from multiple public information sources and extract, preprocess, summarize, and store text data using a generative artificial intelligence model invoked via programmatically generated prompt sentences, and (iii) generate visualization data and dynamically adjust the visualization data on the basis of user state information. Such improvements should reduce the computational and cognitive load associated with manual document review, increase the efficiency and consistency of natural-language processing across large document sets, and provide a more adaptive and responsive human-computer interface.

The specific processing by the specific processing unit 290 of the data processing device 12 in Example 2 is realized by the following means.

The present invention provides a server comprising a processor configured to collect, aggregate, and analyze search history information of a search service acquired via a communication network in order to understand which search terms are used to search for a specified business entity and a competing business entity within a predetermined period, to obtain location information of public information sources related to the competing business entity on the basis of information source management data, to acquire structured document data from the public information sources according to the location information, to automatically extract text data corresponding to notification information from the structured document data, to perform document preprocessing on the text data to generate preprocessed text data by executing data processing including removal of unnecessary information, normalization of character types, and division of long text into a plurality of segments, to generate a prompt sentence including instruction content for summarizing the preprocessed text data, to input the prompt sentence and the preprocessed text data to a generative artificial intelligence model and cause the generative artificial intelligence model to output summary text data so as to generate a summary of the text data, to perform postprocessing on the summary text data to generate summary record data by executing processing including length adjustment, deletion of duplicate sentences, and addition of classification information and by associating attribute information including a competing business entity name, a publication time, and an information type with the summary text data, to store the summary record data in a storage device, to acquire the summary record data via a display control interface, to generate visualization data by arranging the summary record data in chronological order or by category on the basis of the attribute information, and to transmit the visualization data to a display device so that the visualization data is visually displayed on a user terminal and a user can confirm the summary text data in a list form, and further configured to analyze user input information and user behavior history information to estimate an emotional state of a user and to dynamically change the visualization data by adjusting at least one of a display order, an emphasis degree, and a presentation target of the summary record data on the basis of the estimated emotional state and an analysis result of the search history information. This enables the server to implement an integrated, processor-driven pipeline that transforms heterogeneous network-acquired document data and search history information into standardized summary record data using a generative artificial intelligence model with programmatically generated prompt sentences, to store and retrieve such summary record data efficiently, and to adaptively generate and adjust visualization data in response to user-specific state information, thereby improving the technical performance of competitor-monitoring systems in terms of processing efficiency, resource utilization, and effectiveness of the human-computer interaction.

The term “system” refers to an arrangement of one or more computing devices, storage devices, and communication interfaces that are operated together to perform the claimed processing functions.

The term “processor” refers to a hardware processing unit or a combination of hardware processing units, such as a central processing unit or a microcontroller, configured to execute computer-readable instructions to perform logical and arithmetic operations.

The term “communication network” refers to any wired or wireless data communication infrastructure, including local networks and wide area networks, that enables exchange of digital information between the system and external devices or services.

The term “search service” refers to an information retrieval service that receives search queries from users or client devices and returns search results, and that generates search history information based on the received queries.

The term “search history information” refers to data representing past search activity, including at least search terms, timestamps, and optionally associated identifiers such as user identifiers, device identifiers, or region identifiers.

The term “specified business entity” refers to an organization that is the primary subject of analysis in the system and whose search history information and public information are monitored.

The term “competing business entity” refers to an organization that offers products or services that are considered competitive with those of the specified business entity and whose search history information and public information are monitored.

The term “information source management data” refers to data indicating one or more public information sources associated with a competing business entity, including at least location information such as network addresses or resource identifiers.

The term “public information source” refers to any information-providing resource that is publicly accessible via the communication network, such as a website, a feed, or an online publication service.

The term “location information” refers to data that uniquely or sufficiently identifies a public information source on the communication network, such as a uniform resource locator, a network address, or an application programming interface endpoint.

The term “structured document data” refers to document data having a machine-readable structure, such as markup tags or metadata fields, that allows programmatic parsing and extraction of specific portions of the document.

The term “notification information” refers to information contained in structured document data that reports an event or announcement, including but not limited to press releases, news items, product announcements, or policy changes.

The term “text data” refers to character-based data representing natural-language content extracted from structured document data.

The term “document preprocessing” refers to processing applied to text data prior to summarization, including at least removal of unnecessary information, normalization of character types, and division of long text into a plurality of segments.

The term “removal of unnecessary information” refers to a processing operation that deletes content not needed for summarization, such as navigation text, advertisements, script code, style information, or repeated boilerplate.

The term “normalization of character types” refers to a processing operation that converts characters into a standardized representation, such as unifying full-width and half-width characters, normalizing case, or normalizing encoding.

The term “division of long text into a plurality of segments” refers to a processing operation that splits a long sequence of text data into multiple shorter portions, for example based on length thresholds, sentence boundaries, or section markers.

The term “preprocessed text data” refers to text data that has been subjected to document preprocessing and is ready to be provided to a summarization process.

The term “prompt sentence” refers to a machine-readable natural-language or structured instruction that specifies how a generative AI model is to process input text data, including at least a request to summarize the preprocessed text data.

The term “instruction content” refers to content within the prompt sentence that describes the task to be performed by the generative AI model, such as required summary length, focus points, language, or output format.

The term “generative artificial intelligence model” refers to a machine-implemented model that receives input data including a prompt sentence and generates output text data using a learned statistical representation of language, such as a neural network-based language model.

The term “summary text data” refers to text data generated by the generative artificial intelligence model that represents a condensed form of the preprocessed text data while preserving essential information.

The term “postprocessing” refers to processing applied to summary text data after generation by the generative artificial intelligence model, including at least length adjustment, deletion of duplicate sentences, and addition of classification information.

The term “length adjustment” refers to a processing operation that shortens or otherwise constrains the size of the summary text data to satisfy one or more predetermined length conditions.

The term “deletion of duplicate sentences” refers to a processing operation that detects and removes repeated or substantially identical sentences or segments from the summary text data.

The term “classification information” refers to data indicating one or more categories or labels associated with summary text data, such as information type, topic, or relevance level.

The term “summary record data” refers to a data structure that includes summary text data and associated attribute information, and that is stored as a unit in a storage device.

The term “attribute information” refers to metadata associated with summary text data, including at least a competing business entity name, a publication time, and an information type.

The term “publication time” refers to a time value indicating when the notification information or the corresponding structured document data was published or made publicly available.

The term “information type” refers to a classification label indicating a category of content, such as product announcement, price change, partnership, or policy update.

The term “storage device” refers to a hardware component or combination of hardware components, such as a memory device or a disk subsystem, configured to store summary record data and related information.

The term “display control interface” refers to a programmatic interface or module through which the processor obtains summary record data for the purpose of generating visualization data for display.

The term “visualization data” refers to data formatted and organized based on attribute information so as to be suitable for rendering on a display device, including ordering and grouping of summary record data.

The term “chronological order” refers to an arrangement of summary record data according to time information, such as publication time or acquisition time.

The term “category” refers to a grouping dimension for summary record data based on classification information or attribute information, such as information type or business entity.

The term “display device” refers to an output device, such as a monitor, a smartphone screen, or a tablet screen, configured to visually present visualization data to a user.

The term “user terminal” refers to a computing device operated by a user, including at least a display device and a communication interface for receiving visualization data from the server.

The term “user input information” refers to data representing explicit input operations performed by a user, such as clicks, touches, keystrokes, or entered text.

The term “user behavior history information” refers to data representing historical patterns of user interaction with the system, including at least viewing history, navigation paths, and response times.

The term “emotional state” refers to an estimated psychological state of a user, such as interest level, stress level, or engagement, derived from analysis of user input information and user behavior history information.

The term “display order” refers to an arrangement of summary record data in a sequence for presentation in a user interface.

The term “emphasis degree” refers to a level or manner of visual prominence applied to particular pieces of summary record data, such as through font size, color, position, or highlighting.

The term “presentation target” refers to a set of summary record data selected to be shown or hidden in a visualization based on predefined or dynamically determined criteria.

The term “dynamically change the visualization data” refers to a processing operation in which the processor modifies the visualization data during operation, in response to changing conditions such as the estimated emotional state or updated analysis results.

The term “adjusted information” refers to information that has been selected, ordered, or visually emphasized in accordance with dynamic changes applied to the visualization data.

The term “emphasized display” refers to a mode of display in which certain elements are made more visually prominent relative to other elements.

The term “filtered display” refers to a mode of display in which only a subset of available summary text data and attribute information, selected according to specified conditions, is presented to the user.

In one embodiment, a server implements the claimed system by executing a set of software modules on a hardware platform that includes at least one central processing unit (CPU), a main memory, a non-volatile storage device, and a network interface. The server operates under a general-purpose operating system such as a UNIX-like system or a commercial server operating system. The server runs an application layer composed of a web service framework (for example, a framework that provides HTTP endpoints), a data processing layer implemented in a high-level programming language, and a database management system. The server communicates with one or more terminals via a communication network such as the Internet or an intranet.

The server uses a database system, such as a relational database, to store search history information, structured document data, summary record data, attribute information, and user behavior history information. The database stores data in specific data structures, for example: (i) a “search_log” table that contains fields for search term, timestamp, source region, and entity identifier; (ii) a “document_source” table that contains fields for public information source identifier, network location information, and associated business entity identifier; and (iii) a “summary_record” table that contains fields for summary identifier, business entity identifier, publication time, information type, summary text, and classification information. The server uses indices on key columns such as timestamp and business entity identifier so that retrieval of relevant records is computationally efficient.

The server executes a search-data analysis module that accesses search history information provided by an external search service. The server uses the network interface to call an application programming interface (API) of the search service and to receive search history information as structured data, for example as records including query text, time, and region. The server normalizes and aggregates these records by converting all query texts into a standard character encoding, removing stopwords, and grouping identical terms by hash key to construct term frequency vectors per business entity and period. The server stores aggregated term statistics as numeric arrays in the database. This data structure allows the processor to compute similarity measures, trends, and comparative metrics using vector operations and matrix multiplications, which are more efficient and reproducible than ad hoc human inspection of logs.

The server executes an information-source acquisition module that uses the database-stored information source management data to obtain location information of public information sources such as web pages or programmatic feeds related to competing business entities. The server uses the network interface to send HTTP requests to these locations and to receive structured document data, for example in markup formats or structured feed formats. The server stores the raw structured document data temporarily in a document store and then passes the data to a parsing module.

The server executes a parsing module that analyzes the structure of each document using a markup parser. The parser builds a tree representation of the document, traverses node paths matching predefined patterns (for example, title nodes, body nodes, metadata nodes), and extracts text data that corresponds to notification information such as press releases or announcements. The server removes markup tags, script blocks, and style information and converts the extracted content into plain text sequences. The server then executes document preprocessing, which includes operations such as removal of repeated boilerplate segments detected by substring matching, normalization of character types, segmentation of sentences using language-specific tokenization rules, and partitioning of very long documents into segments that do not exceed a specified token length. These steps produce preprocessed text data that is specially tailored for input to a generative AI model in a way that respects memory and token constraints and removes noise that would otherwise degrade model performance.

The server constructs a prompt sentence for each piece of preprocessed text data. The server uses a prompt construction module that selects a template based on classification information of the notification type and fills the template with instruction content and the preprocessed text. For example, the server can generate prompt sentences such as:
“Summarize the following competitor press release in 2 sentences. Focus on the product name, main features, target customers, and planned release date: [press release text].”
“Summarize the following press release in one or two sentences, highlighting which products have changed price and whether prices increased or decreased: [press release text].”
“Summarize the following partnership announcement in 2-3 sentences, focusing on the partner organizations, the purpose of the partnership, and the expected benefits: [press release text].”
“Create a concise business summary (maximum 120 words) of the following competitor announcement, emphasizing strategic impact and potential implications for our organization: [press release text].”

By programmatically generating these prompt sentences, the server standardizes the interaction with the generative AI model and avoids inconsistencies that occur when human operators formulate free-form requests. The prompt sentence and the associated preprocessed text data form a well-defined input structure that the generative AI model can handle deterministically.

In one embodiment, the generative AI model is implemented as a neural-network-based language model using a transformer architecture. The server stores a model configuration that defines the number of layers, the dimensionality of hidden representations, the number of attention heads, and the vocabulary used for tokenization. The server uses a tokenizer module that maps each input character sequence in the prompt sentence and the preprocessed text data to a sequence of token identifiers according to a subword segmentation scheme. The server then provides the token sequence to the neural network, which comprises stacked self-attention layers and feed-forward networks. Each attention layer computes weighted combinations of token representations using learned query, key, and value matrices. During training, gradient-based optimization has been performed on large corpora of text data. A loss function such as cross-entropy has been used to measure prediction error, and a weight-update algorithm such as stochastic gradient descent or an adaptive gradient method has been used to adjust model parameters. Through this training, the model has learned statistical relationships between tokens and sequences that are exploited during generation. The server interacts with the generative AI model through an inference engine. The inference engine reads the input token sequence, applies the neural network layer by layer to compute output logits, and then applies a decoding algorithm such as greedy decoding or beam search to generate an output token sequence representing summary text data. The server controls parameters such as maximum output length, temperature, and top-k or nucleus sampling thresholds to balance determinism and diversity in the generated summary. The server then maps the output token sequence back to characters and stores the resulting summary text as structured text data.

The server executes a postprocessing module that operates on the summary text data. The postprocessing includes length control, in which the server counts characters or tokens and truncates or requests regeneration if the summary exceeds certain limits, and duplicate sentence elimination, in which the server computes similarity scores between sentences using cosine similarity over vector embeddings and removes sentences above a similarity threshold. The server also attaches classification information by applying a classification algorithm that may use a rule-based system or a secondary machine-learning model trained on features such as keyword frequencies, sentence embeddings, and metadata. For example, the server can assign categories such as “product announcement” or “price change” based on the presence of specific domain terms and patterns. The result is summary record data that includes the summary text, the business entity identifier, the publication time, the information type, and classification labels.

The server manages this summary record data in the storage device using data structures optimized for query performance. The server maintains indices by business entity, publication time, and information type. The server also maintains derived aggregates such as the count of summaries per entity per day and distribution of information types, which are maintained via incremental updates whenever new summary record data is stored. These data structures enable the server to retrieve only the necessary portions of data for visualization, thereby reducing input/output operations and improving performance of the visualization pipeline.

The server generates visualization data by querying the database for summary record data that matches certain constraints, such as time range or entity set, and then sorting or grouping the results based on attribute information. The server constructs a response structure that includes the ordered list of summaries, count metrics, and grouping keys. The visualization data is transmitted to the terminal using efficient serialization formats through the network interface. Because the visualization data is already pre-sorted and filtered at the server, the terminal does not need to perform heavy processing, which reduces terminal energy consumption and network bandwidth use.

The terminal receives the visualization data and renders it on a display device. The terminal may be a handheld device, a tablet, or a desktop computer. The terminal runs a graphical user interface that presents summary entries as list items, cards, or tiles. Each item displays at least the competing business entity name, the publication time, the information type, and the summary text. The terminal allows the user to interact by selecting items, scrolling, and applying filters. When the user selects an item, the terminal sends a request to the server to retrieve the corresponding full text or additional generated summaries from the summary record data or original document data. The terminal then displays the detailed information alongside or below the summary so that the user can rapidly move between overview and detailed views without loading whole websites externally.

The user operates the terminal to inspect competitor information and to adjust filters such as time windows or categories. The user can, for example, select to display only summaries tagged as “product announcement” for a particular competing business entity within the last month. The terminal transmits these preferences to the server, and the server responds with newly filtered visualization data derived from stored summary record data, thereby enabling efficient focused analysis.

The server also uses user input information and user behavior history information to estimate a user's emotional state and to adapt the visualization. The server logs interaction events such as clicks on certain categories, dwell time on summary items, scroll patterns, and frequency of opening detailed views. The server stores these events as time-stamped records and computes behavior features such as average reading time per item, ratio of opened details to displayed summaries, and diversity of categories accessed. The server processes these features using a state-estimation model, which can be implemented as a supervised learning classifier, for example a neural network or gradient-boosted trees. The model has been trained on labeled data representing user states such as “highly engaged” or “overloaded,” using a loss function such as cross-entropy and an optimization algorithm to adjust parameters. The server computes a probability distribution over emotional states for the current session and selects the most probable state as the estimated emotional state.

Based on the estimated emotional state, the server dynamically modifies the visualization data. If the server detects an overloaded or low-attention state, the server may reduce the number of items shown per page, increase font size for high-priority summaries, and simplify category options. If the server detects a highly engaged state, the server may increase the information density by including secondary metrics and additional summaries. The server applies deterministic rules that map estimated states to visualization parameters, such as maximum list length, highlight color schemes, and ordering weightings that combine publication time and classification importance. This dynamic adaptation is computed inside the server before sending data to the terminal, thereby shifting processing load away from the terminal and providing a consistent behavior across different device types.

From a technical standpoint, the described configuration improves computer technology in several ways. The server reduces storage and communication overhead by storing and transmitting compact summary record data instead of full document content for every interaction. Because the server precomputes summaries and maintains indexed summary record data, the time required to answer user queries is significantly lower than in systems that retrieve and process full documents on demand. The preprocessing and postprocessing pipelines, combined with a generative AI model, result in standardized, machine-friendly text structures that can be quickly retrieved, ranked, and displayed, which is not achievable with unstructured manual review.

Moreover, the use of a transformer-based generative AI model with programmatically constructed prompt sentences provides a non-conventional way of processing text data. Rather than simply automating human reading, the server encodes documents into token sequences, applies multi-head self-attention, and uses trained parameters to capture long-range dependencies. This enables the system to identify salient points across entire documents more consistently than rule-based or manual methods. By integrating document preprocessing, model inference, and postprocessing in a single pipeline that is invoked by the processor, the system achieves higher summarization accuracy and reduced noise in the stored summaries. This improved quality translates into fewer false positives and reduced need for re-processing, thereby improving the overall computational efficiency.

The dynamic visualization mechanism based on estimated emotional state further enhances resource utilization. Instead of statically sending all available summary record data to the terminal, the server tailors the volume and emphasis of data to the user's current state. This reduces unnecessary transmissions and rendering operations when the user is not able or willing to consume dense information, and it allows concentration of computational resources on the most relevant items. The ability to modify visualization parameters in real time at the server side constitutes an improvement in how graphical data is structured and delivered, distinct from mere business-level personalization.

In alternative embodiments, the server can deploy different generative AI models or architectures, such as encoder-decoder transformers or recurrent-network-based language models, as long as the model accepts prompt sentences and text inputs and outputs summary text. The training process can include regularization techniques, learning rate scheduling, and data augmentation such as synonym replacement or sentence reordering to improve robustness. The server can also use a federated training setup, in which logs from multiple installations are aggregated in anonymized form to refine the summarization or state-estimation models. In another variation, the server may execute some inference operations on specialized hardware such as a graphics processing unit or tensor processing unit, thereby accelerating the generation of summary text data and further reducing latency. The terminal can also be implemented as a thin client that performs minimal processing and relies on the server for all summarization and visualization logic, or as a rich client that caches summary record data for offline viewing. In the latter case, the server can encode summary record data into compact binary formats and transmit them once, while the terminal locally re-orders and filters the data according to later user interactions. The user may interact with the system from multiple terminals; in such cases, the server aggregates behavior history across devices to estimate a more complete emotional state and to synchronize visualization preferences.

Through these embodiments, the system as implemented by the server, terminals, and user interactions provides a concrete improvement in computer-implemented information processing. The server restructures raw search history and document data into indexed summary record data using a defined pipeline that includes generative AI model inference guided by precise prompt sentences. The server manages storage and retrieval of this data using optimized data structures and dynamically adapts visualization on the basis of user state. The combination of these elements yields technical effects such as faster response time, reduced network traffic, more efficient utilization of processing and storage resources, improved quality of generated summaries, and more effective human-computer interaction, beyond mere automation of manual review.

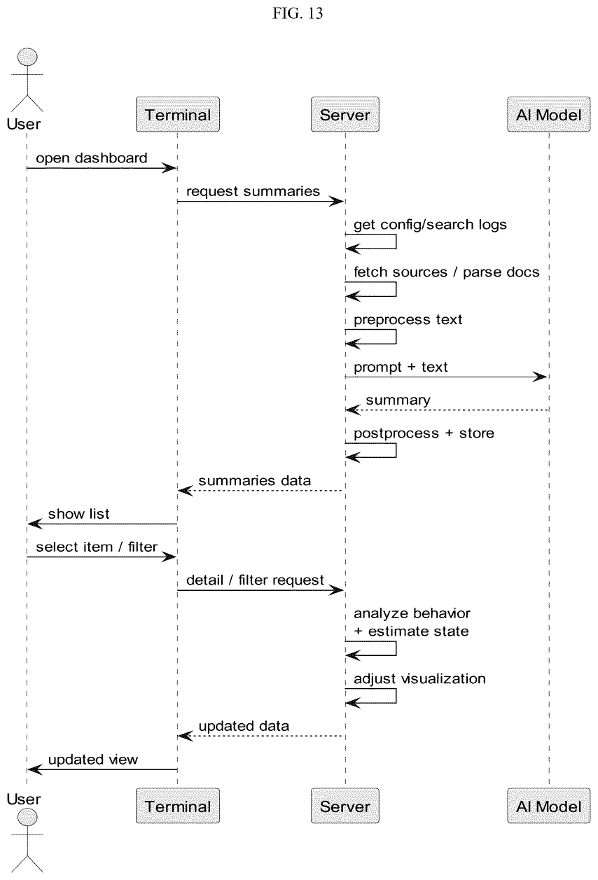

The following describes the processing flow using FIG. 13.

### Step 1

The server initializes system configuration.
The server uses configuration data stored in a storage device as input, including a list of business entities, information source locations, model parameters, and schedule settings. The server parses this configuration, loads it into main memory, and constructs internal data structures such as lists of target entities and mappings from entity identifiers to public information sources. The output is an in-memory configuration object that other modules can reference during subsequent processing.

### Step 2

The server acquires search history information from a search service.
The server uses entity identifiers and a time range from the configuration as input and sends requests over a communication network to a search service interface. The server receives search history information records, each containing at least a search term and a timestamp. The server cleans and normalizes the search terms, for example by lowercasing and removing special characters, and aggregates them per entity and period. The output is a set of aggregated search history datasets stored in a database as numeric term-frequency vectors.

### Step 3

The server retrieves information source management data.
The server uses entity identifiers as input and queries a database table that associates each entity with one or more public information sources and their location information. The server reads records containing network addresses and feed identifiers and converts them into a crawl plan, which defines which locations to access and how frequently. The output is a structured list of crawl targets, each including entity identifier, location information, and crawl parameters.

### Step 4

The server collects structured document data from public information sources.
The server takes the crawl targets as input and, for each target, sends network requests (for example, HTTP GET requests) to the corresponding network addresses. The server receives structured document data such as markup documents or feed entries and verifies response status codes and content types. The server stores the raw documents temporarily in a document store with metadata including retrieval time and entity identifier. The output is a collection of raw structured documents associated with their source entities.

### Step 5

The server parses structured document data and extracts text data.
The server uses the raw structured documents as input and applies a document parser that constructs a tree representation of each document. The server traverses this tree following predefined patterns to locate title nodes, body nodes, and metadata nodes, and extracts text segments corresponding to notification information such as press releases or announcements. The server removes markup tags, script content, and style definitions, and concatenates relevant text segments into plain text strings. The output is a set of extracted text data records, each linked to an entity identifier and publication time.

### Step 6

The server performs document preprocessing on the extracted text data.
The server uses the extracted text data records as input and executes multiple preprocessing operations. The server identifies and removes boilerplate segments by matching repeated substrings or known patterns, normalizes character types (for example, converting to a unified encoding and normalizing case), and segments the text into sentences using language-specific tokenization rules. When a text exceeds a predefined length or token limit, the server divides it into multiple segments while preserving sentence boundaries. The output is preprocessed text data segments, each associated with original document identifiers and entity identifiers.

### Step 7

The server generates prompt sentences for the generative AI model.
The server uses the preprocessed text data segments and notification types as input. The server selects a prompt template based on notification type (for example, product announcement, price change, or partnership) and fills the template with instruction content and the corresponding text segment. For example, the server may generate prompt sentences such as: “Summarize the following competitor press release in 2 sentences. Focus on the product name, main features, target customers, and planned release date: [press release text].” The server combines each prompt sentence with its corresponding text segment into a structured request object. The output is a list of prompt-text pairs prepared for summarization.

### Step 8

The server calls the generative AI model to generate summary text data.
The server uses the prompt-text pairs as input and encodes each pair into a format accepted by the generative AI model, such as a concatenated string or a structured payload. The server sends these inputs to a generative AI model interface over a network or invokes a local inference engine. Internally, the model tokenizes the input, applies a neural network with a transformer architecture, computes self-attention over tokens, and generates output tokens that form a summary. The server receives the generated token sequences, decodes them back into text, and checks for errors or empty outputs. The output is summary text data associated with each original text segment.

### Step 9

The server performs postprocessing on the summary text data and constructs summary record data.
The server uses the raw summary text data and associated metadata as input. The server measures the length of each summary in characters or tokens and truncates or regenerates the summary if it exceeds predefined length constraints. The server splits the summary into sentences, computes similarity scores between sentences, and removes sentences that are duplicates or highly similar to earlier ones. The server then determines classification information such as information type by applying rule-based checks or a separate classifier using features derived from the summary. The server creates a summary record data structure that includes the cleaned summary text, entity identifier, publication time, information type, and classification labels. The output is a set of normalized summary record data objects.

### Step 10

The server stores summary record data in a storage device.
The server uses the summary record data objects as input and writes them into database tables with fields for identifiers, entity identifiers, timestamps, information types, summary texts, and classification labels. The server updates indexes on key fields such as entity identifier and publication time and computes derived aggregates such as daily counts of summaries per entity. The output is a persistent collection of indexed summary record data that can be efficiently retrieved for visualization and analysis.

### Step 11

The server generates visualization data based on summary record data.
The server uses query parameters received from the terminal, such as selected entities, time ranges, and categories, as input and issues database queries over the summary record data. The server orders the results chronologically or groups them by category according to attribute information, and constructs visualization structures such as lists, grouped sections, and count statistics. The server formats this information into a compact data representation suitable for transmission to a terminal. The output is visualization data that describes how summaries should be displayed.

### Step 12

The server transmits visualization data to the terminal.
The server uses the visualization data as input and sends it through a communication network using a transport protocol. The server may apply compression or pagination to reduce the amount of data transmitted. The output is a network response received by the terminal, containing ordered summary items and associated attributes for display.

### Step 13

The terminal receives and renders visualization data.
The terminal uses the visualization data from the server as input and parses it into internal data structures, such as arrays of summary items with attributes. The terminal maps each item to a user interface component, for example a list row or card, and arranges these components on the display in the order specified by the visualization data. The terminal applies visual styles such as fonts, colors, and icons according to information type or classification labels. The output is a rendered screen that presents summary text data and associated information to the user.

### Step 14

The user interacts with the displayed summaries.
The user uses the rendered screen as input and performs operations such as scrolling through the list, selecting specific summary items, and applying filters or sort options. The user's actions generate input events on the terminal, such as taps, clicks, or gestures. The terminal records these events and forwards relevant control commands and filter settings to the server. The output is a set of interaction events and preferences that reflect the user's current focus and intentions.

### Step 15

The server analyzes user behavior history information and estimates an emotional state.
The server uses the interaction events and historical behavior records as input and aggregates them into features such as average dwell time on items, frequency of detail view openings, and distribution of accessed categories. The server feeds these features into an emotional state estimation model, which computes scores or probabilities for different emotional states. The server selects an emotional state label based on these scores and stores it in association with the current session. The output is an estimated emotional state that will guide dynamic visualization adjustments.

### Step 16

The server dynamically adjusts visualization data based on the estimated emotional state and search history analysis.
The server uses the estimated emotional state, aggregated search history metrics, and existing summary record data as input. The server applies rules or algorithms that map emotional state values and search trends to visualization parameters such as display order, emphasis degree, and presentation target. For example, the server may prioritize high-relevance summaries when the user appears overloaded or expand the number of displayed items when the user appears highly engaged. The server regenerates visualization data accordingly, adjusting which summaries are included and how they are marked for emphasis. The output is updated visualization data tailored to the current user state and analysis context.

### Step 17

The terminal updates the display according to the adjusted visualization data.
The terminal uses the updated visualization data as input and re-renders the user interface. The terminal may reorder items, change highlight styles, or hide low-priority summaries according to the new visualization parameters. The terminal ensures that the transition is smooth, for example by animating changes or maintaining user scroll position when possible. The output is an adapted display that presents summary text data in a manner optimized for the user's inferred state and current analytical needs.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional information analysis systems that monitor market and competitor activity generally rely on static rule-based pipelines. Such systems typically (i) collect search statistics from network search services, (ii) crawl publicly available documents such as press releases and news articles, and (iii) display aggregated reports and dashboards. However, these systems suffer from several technical limitations.

First, conventional systems require a developer or analyst to predefine fixed query logic and visualization templates. The system is usually not able to interpret arbitrary natural-language instructions from a user and dynamically reconfigure its data acquisition and processing pipeline. As a result, the system executes generic queries against search and document sources, regardless of the user's specific intent, causing unnecessary network traffic, redundant processing, and increased response latency.

Second, conventional systems treat search data, document data, and user context as largely independent signals. Document scraping, search trend analysis, and summarization are often implemented as separate modules with limited interaction. These modules generally do not exploit a generative AI model as a unified reasoning component that can consume heterogeneous inputs (e.g., document text, search statistics, user prompts) under structured, dynamically constructed prompt sentences. Consequently, the system cannot flexibly adapt the level of abstraction, structure, and focus of its outputs, and frequently presents either overly detailed or overly shallow information.

Third, known systems typically ignore the real-time emotional state of the user, or at best use coarse personalization based on static profiles. User interfaces are usually tuned for an average user and do not adjust content density, ordering, or presentation format according to estimated user emotion derived from multimodal signals such as behavior logs, typed text, facial images, and audio. This leads to inefficient human-computer interaction: a stressed or overwhelmed user is still exposed to the same volume and complexity of information as a highly engaged user, which can increase cognitive load and reduce effective use of the system.

Fourth, existing human-in-the-loop workflows for market and competitor analysis usually require the user to manually translate business questions into system-specific queries and to manually aggregate outputs from multiple tools. Even when a generative AI model is available, prompt sentences are often handcrafted and disconnected from the system's internal state, such as search trend results, topic annotations, and stored user histories. This separation prevents the system from automatically constructing context-rich prompt sentences that guide the generative AI model to produce task-specific, structurally constrained answers optimized for business-strategy planning.

Fifth, conventional systems generally do not learn from accumulated interaction data in a systematic way to improve the orchestration of data sources, prompt construction, and presentation logic. Interaction logs, emotional-state estimates, and browsing histories are rarely used as training signals to refine how the system builds prompt sentences and how it selects and structures the information to display. As a result, the system's behavior remains largely static and does not converge toward more efficient, user-appropriate responses over time.

Accordingly, there is a need for a computer-implemented system that (i) interprets user natural-language instructions to configure data acquisition and analysis, (ii) integrates search information and document information into a unified generative AI-driven reasoning layer using dynamically generated prompt sentences, (iii) estimates the user's emotional state from multimodal signals and adjusts content selection and presentation accordingly, and (iv) adaptively refines its own prompt-generation and display strategies based on logged user behavior and emotional-state histories. Such a system would improve computer technology by enabling more efficient use of network and processing resources, reducing user interaction steps, and generating outputs that are structurally and semantically tuned to both the analytical task and the user's current condition.

The specific processing by the specific processing unit 290 of the data processing device 12 in Application Example 2 is realized by the following means.

The present invention provides a server comprising a processor and a memory storing instructions that, when executed by the processor, cause the processor to acquire information from network-based information sources and search-information sources, extract and store document information as text information, analyze search information to obtain aggregated, time-series, and statistical information, receive and interpret natural-language instruction sentences from a user to identify required information sources and processing parameters, pre-process the document information and the search information by natural-language processing to derive word-sequence information, emotion information, topic information, and target information, generate and input dynamically constructed prompt sentences to a generative AI model together with at least one of the document information and the search information so as to obtain summary information, analysis information, integrated summary information, and proposal information, convert these outputs into display data including visualization information, acquire multimodal user information from a user terminal to estimate an emotional state of the user, adjust contents, level of detail, priority, and presentation format of the display data according to the estimated emotional state, and record and exploit user instruction histories, browsing histories, action histories, and emotional-state histories to update prompt-generation and display-generation methods in a learning manner. This enables the server to technically improve information processing by automatically orchestrating heterogeneous data sources and a generative AI model through context-aware prompt sentences, by dynamically tailoring computational workflows and visual outputs to both user intent and user emotion, and by progressively optimizing system behavior based on accumulated interaction data, thereby reducing processing redundancy, lowering cognitive load on the user, and enhancing the efficiency and effectiveness of computer-implemented market and competitor analysis.

The term “processor” refers to a hardware-based information processing unit, such as a central processing unit or a microcontroller, that executes instructions to perform arithmetic, logical, control, and input/output operations in the system.

The term “memory” refers to an electronic storage component, such as semiconductor memory or a storage device, configured to store program instructions, configuration data, intermediate data, and results used by the processor.

The term “network-based information source” refers to a remote computing resource accessible via a communication network, such as a server or service that provides document information, news information, or other content through a network interface.

The term “search-information source” refers to a computing resource that provides search-related data, such as query logs, search-frequency data, related-query data, or analytics information derived from user search behavior.

The term “search information” refers to data obtained from a search-information source, including search terms, query frequencies, time-series search volumes, related search expressions, and other metrics that characterize how information is searched over time.

The term “document information” refers to text-based content obtained from a network-based information source, such as articles, announcements, press statements, or other textual documents containing sentences, paragraphs, and semantic content.

The term “text information” refers to document information that has been stored in a text-encoded form, such as character strings or tokens, suitable for processing by natural-language processing techniques.

The term “expression” refers to a word, phrase, or sequence of characters used as a search term or keyword to retrieve information from a search-information source.

The term “own organization” refers to an entity, such as a business organization or an institution operating the system, whose market activity or information is to be analyzed by the system.

The term “competing organization” refers to an entity that offers products or services in the same or a related market as the own organization and whose activity or information is to be analyzed as competitive information.

The term “specified period” refers to a time interval designated by configuration data, a user instruction, or a system rule, during which search information or document information is collected or analyzed.

The term “natural-language instruction sentence” refers to a sequence of words expressed in a human language and input by a user to request the system to perform a particular analysis, retrieval, or summarization task.

The term “inquiry sentence” refers to a natural-language instruction sentence that requests information, a result, or an explanation from the system, such as a question regarding trends, comparisons, or recommendations.

The term “information source” refers to any logical or physical origin of data, including network-based information sources, search-information sources, local databases, or data streams, which the system accesses to acquire information.

The term “target period” refers to a time range determined from a user instruction or system configuration and used as a constraint when collecting or analyzing search information or document information.

The term “target organization” refers to an organization identified by the system as a subject of analysis, such as the own organization, a competing organization, or another entity specified by a user instruction.

The term “processing content” refers to the type of computational operation to be executed by the system, such as collecting data, aggregating metrics, performing natural-language processing, generating summaries, or producing comparative analyses.

The term “natural-language processing” refers to a set of algorithmic techniques for analyzing and transforming human-language text, including operations such as tokenization, lemmatization, part-of-speech tagging, parsing, entity recognition, and sentiment analysis.

The term “word-sequence information” refers to ordered representations of linguistic units, such as tokens or terms derived from text information, that preserve or encode the order of words in sentences or documents.

The term “emotion information” refers to data representing an inferred affective state associated with text, user behavior, or multimodal signals, such as scores or labels indicating states like positive, negative, neutral, stressed, or excited.

The term “topic information” refers to data representing semantic categories or themes that characterize document information, such as labels or vectors indicating subject matter, product categories, or thematic clusters.

The term “target information” refers to data that identifies entities or aspects to which document information or analysis results relate, such as particular products, services, organizations, or time periods.

The term “generative AI model” refers to a trained computational model, such as a large language model or other machine-learned generative model, that generates new text or other outputs based on input data and conditioning instructions.

The term “prompt sentence” refers to a text input provided to a generative AI model that specifies a task, constraints, or context, and guides the generative AI model in generating a desired output.

The term “summary information” refers to condensed text derived from document information or analysis results, in which salient points or core content are represented in a reduced form compared to the original information.

The term “analysis information” refers to derived data obtained by computational processing of raw information, including aggregated metrics, categorized results, comparative evaluations, or other processed outputs.

The term “integrated summary information” refers to summary information that combines or synthesizes multiple pieces of summary information or analysis information into a higher-level description of overall trends or patterns.

The term “proposal information” refers to generated content that suggests actions, strategies, or decisions, such as recommendations for business planning, marketing, or competitive responses, based on analyzed information.

The term “visualization information” refers to data structures describing how to represent information graphically, such as configurations for charts, graphs, diagrams, or other visual elements indicating trends or relationships.

The term “display data” refers to data formatted for rendering on a display device, including textual elements, graphical elements, layout parameters, and interaction elements.

The term “display device” refers to an output apparatus, such as a monitor, screen, or graphical user interface component, configured to visually present display data to a user.

The term “user terminal” refers to an end-user computing device, such as a workstation, portable terminal, or mobile device, equipped with an input interface and a display device and configured to communicate with the server.

The term “user action information” refers to data representing user interactions with a user interface, such as click events, scroll events, key presses, pointer movements, and other operational inputs.

The term “input information” refers to data directly entered by the user, including natural-language instruction sentences, typed text, selected options, or other input values.

The term “image information” refers to digital image data, such as frames captured by an image sensor, including facial images or other visual scenes associated with user interaction.

The term “audio information” refers to digital audio data, such as signals captured by a microphone, including user speech or other sounds associated with user interaction.

The term “emotional state” refers to an inferred psychological or affective condition of the user, such as joy, frustration, stress, calmness, or interest, estimated from one or more of action information, input information, image information, and audio information.

The term “level of detail” refers to a degree of granularity of information presented to the user, such as the number of items shown, the depth of explanation provided, or the extent of contextual information included.

The term “priority” refers to an ordering or weighting assigned to items of information, determining their selection, ranking, or prominence in the, or within, display data.

The term “presentation format” refers to a mode or style of presenting information to the user, including aspects such as text layout, use of bullet points or tables, choice of chart types, and arrangement of user-interface components.

The term “additional natural-language instruction sentence” refers to a subsequent instruction expressed in natural language by the user after an initial interaction, intended to refine, extend, or redirect the analysis performed by the system.

The term “comparison information” refers to analysis information that expresses similarities, differences, advantages, or disadvantages between two or more targets, such as products, organizations, or time periods.

The term “evaluation information” refers to analysis information that assigns scores, ratings, or qualitative judgments to targets or strategies based on predetermined criteria or inferred metrics.

The term “instruction history” refers to a stored record of natural-language instruction sentences or other commands issued by the user over time.

The term “browsing history” refers to a stored record of information items, pages, or views that the user has accessed or displayed using the system.

The term “action history” refers to a stored record of user action information over time, including sequences of clicks, scrolls, pointer movements, and other interface interactions.

The term “emotional-state history” refers to a stored record of estimated emotional states of the user over time, correlated with user actions, viewed content, or system responses.

The term “learning manner” refers to a mode of operation in which the system updates parameters, rules, or models based on observed data, such as user histories or performance metrics, using machine learning or adaptive algorithms.

The term “update of a generation method of the prompt sentence” refers to a modification of rules, templates, parameters, or models that determine how prompt sentences are constructed for the generative AI model, performed in response to accumulated interaction data.

The term “update of a generation method of the display data” refers to a modification of rules, templates, parameters, or models that determine how display data is assembled or structured, performed in response to accumulated interaction data or estimated user needs.

In one embodiment, a server, a terminal, and a user cooperate to implement the claimed system. The server includes at least one processor, a memory, a non-transitory storage device, and a network interface. The terminal includes a processor, a memory, an input interface such as a keyboard or touch screen, and an output interface such as a display device, camera, and microphone. The user operates the terminal to issue natural-language instructions and to inspect analysis outputs.

The server executes software modules implemented, for example, in a general-purpose programming language running on an operating system. The server uses communication libraries to exchange data with external network-based information sources and search-information sources over a packet-based network. The server uses a database management system, such as a relational database engine, to store and retrieve structured representations of search information, document information, user histories, and model parameters. The server uses natural-language processing libraries, numerical computation libraries, and machine learning libraries to implement text pre-processing, feature extraction, model inference, and visualization data preparation.

The server stores, in the memory, program instructions defining multiple functional components: a data acquisition component, a search-analysis component, a natural-language instruction analyzer, a text pre-processing component, a generative AI interface component, a visualization generator, an emotion-estimation component, and an adaptive controller.

The server uses the data acquisition component to connect to network-based information sources, such as web servers providing documents, and to search-information sources, such as search analytics servers. The server issues HTTP requests to these sources and receives responses containing document information in markup formats and search information in structured formats. The server converts each response into an internal data structure, such as a record containing a source identifier, a timestamp, a content field, and metadata fields. The server stores these records into the database, indexed by organization identifiers, topic identifiers, and time intervals.

The server uses the search-analysis component to transform raw search-information records into aggregated, time-series, and statistical data structures. The server represents search information for each expression as a time-indexed array of numeric values. The server applies numerical aggregation operations, such as summation and averaging, along with resampling operations to normalize different sampling granularities. The server computes derived features, such as moving averages, growth rates, and volatility measures. The server associates each feature array with identifiers for an own organization or a competing organization.

The server uses the natural-language instruction analyzer to parse user-provided natural-language instruction sentences. The server receives an instruction sentence from the terminal as a string and tokenizes the string into tokens. The server applies a syntactic parser and a semantic interpreter implemented using a trained neural-network model, for example a transformer-based sequence model, to identify entities such as organization names, product names, time expressions, and requested analysis types. The server maps these entities into internal control variables: a list of target organizations, a target period, and processing content types such as “trend analysis,” “document summarization,” or “comparative evaluation.”

The server uses the text pre-processing component to process document information and search information. The server tokenizes the document text, removes stopwords, performs lemmatization, and computes word-sequence representations such as token indices and embedding vectors. The server applies named-entity recognition to identify entities relevant to markets and products. The server computes sentiment scores for each document using a sentiment classifier that maps feature vectors into emotion information labels. The server generates topic information by projecting document representations into a topic space, for example, via a trained topic model or by clustering document embeddings. The server attaches the emotion information, the topic information, and the target information to each document record in the database.

The server uses the generative AI interface component to communicate with a generative AI model. In one embodiment, the server connects to an external generative AI service providing a large language model. In another embodiment, the server executes a generative AI model locally, implemented as a multi-layer neural network with an encoder-decoder architecture and attention mechanisms. The generative AI model maintains parameter tensors representing learned weights and biases, obtained by training on large corpora using a sequence-to-sequence learning objective.

The server generates a prompt sentence that conditions the generative AI model on a specific task. The server constructs the prompt sentence by concatenating a task instruction portion, context information derived from the analysis, and the relevant document text or search data description. For example, the server generates prompt sentences such as:
“Summarize the following competitor press release about new mobile devices in three bullet points, focusing on main features, target customers, and positioning: [press release text].”
“Based on the following news article summaries and search trend descriptions for the last 14 days, explain the overall market trend in five concise bullet points suitable for an advertising planner: [summaries and trend description].”
“Using the existing database of press releases and search statistics, compare our product X with the latest competing products and list three advantages and three disadvantages for our current advertising campaign: [context description].”

The server encodes the prompt sentence and any additional text into sequences of tokens using the vocabulary of the generative AI model. The server feeds the token sequences into the model's input layer and performs inference using the model's trained parameters to produce output token sequences that constitute summary information, analysis information, integrated summary information, or proposal information. Internally, the generative AI model applies attention-based transformations and non-linear activations to compute context-aware token representations and generates each output token by sampling or selecting from a probability distribution parameterized by the model's weights and the intermediate states.

The server uses the visualization generator to convert summary information, analysis information, and integrated summary information into display data. The server maps time-series search data into chart configurations that define axes, series, and graphical styles for line graphs or bar charts. The server maps document-level scores, such as sentiment or topic membership, into tables or categorical plots. The server embeds generated text summaries into layout templates that specify titles, bullet lists, and links. The server generates a structured visualization description, for example a tree of components representing panels, charts, and text regions.

The server uses the emotion-estimation component to estimate an emotional state of the user. The server receives user action information, input information, image information, and audio information from the terminal. The terminal provides, for example, click coordinates, scroll distances, keypress timings, facial image frames captured by a camera, and audio samples captured by a microphone. The server extracts behavioral features such as average scroll speed, dwell time on specific content elements, and typing speed. The server uses a convolutional or residual neural network to process facial images and compute facial-expression feature vectors. The server uses an audio feature extractor to obtain pitch, energy, and spectral features from the audio samples.

The server concatenates behavioral features, visual features, and audio features into a multimodal feature vector and inputs the feature vector into an emotion classifier model. The emotion classifier is implemented as a neural network having one or more fully-connected layers and a softmax output layer that yields probabilities for discrete emotional states such as “calm,” “stressed,” “interested,” and “bored.” The server selects an emotional-state label based on the highest probability and uses the label as the emotional state of the user.

The server uses the adaptive controller to adjust the content and presentation of the display data based on the emotional state. The server defines rules or learned mappings that relate emotional states to configuration parameters such as the level of detail, the number of items to display, and the prominence of specific information categories. For example, when the emotional state is “stressed,” the server reduces the number of displayed summaries, increases font sizes, and highlights key conclusions. When the emotional state is “interested,” the server expands details, shows additional comparative analyses, and includes more granular graphs. The server modifies the visualization description accordingly and regenerates display data.

The server stores user instruction histories, browsing histories, action histories, and emotional-state histories in the database. Each history entry includes timestamps, identifiers for viewed content, recorded interactions, and predicted emotional states. The server uses these histories to train or update models that generate prompt sentences and display configurations. For example, the server uses a recurrent or transformer-based model that takes as input a sequence of past interactions and outputs preferred output structures or prompt modifiers. The server defines an error function that measures the discrepancy between predicted user engagement and actual engagement metrics, such as reading duration or click-through rates. The server updates model weights using gradient-based optimization to minimize the error function over historical data.

The terminal executes client-side software, such as a browser script or native application, to interact with the server. The terminal renders display data received from the server on the display device. The terminal draws charts, tables, and text according to the visualization description. The terminal provides input elements that allow the user to enter natural-language instruction sentences. The terminal captures user interactions, such as clicks and scrolls, and periodically sends user action information to the server. The terminal accesses the camera and microphone, with user permission, to capture image information and audio information and transmit them to the server in compressed formats for emotion estimation. The user operates the terminal to input instruction sentences such as:
“Show me the latest competitor announcements about new devices in the last two weeks and summarize them in three bullet points.”
“Get the search trend of ‘Product A’ for the past week and plot the changes in a line graph.”
“Summarize the media's reaction to competitor Y's last three product launches and suggest how we should position our next campaign.”

The user reads the displayed summaries, analysis graphs, and integrated summaries, and may issue follow-up instruction sentences to refine the analysis.

The system produces technical effects that go beyond a mere automation of human mental tasks. The server uses structured data representations, neural-network inference, and adaptive control logic to reduce redundant network calls and computational steps. Because the natural-language instruction analyzer and the generative AI interface generate prompt sentences that explicitly constrain the task, the server limits data acquisition to relevant time periods and organizations, which reduces network traffic and storage usage. The server's multimodal emotion-estimation component enables dynamic adjustment of output complexity, which decreases the amount of unnecessary rendering and client-side processing when the user requires only high-level summaries. The adaptive controller's learning-based update of prompt-generation and display-generation methods improves convergence of outputs to user preferences, resulting in fewer interaction cycles and faster task completion.

The server uses non-conventional dataflows that integrate search information, document information, user instructions, and user emotion into the construction of prompt sentences for the generative AI model. This differs from a human operator manually composing summaries or prompts, because the server uses algorithmic analysis of text and behavior features to select and weight the content included in the prompt. By combining topic information, emotion information of documents, and time-series search statistics inside the prompt sentence, the server causes the generative AI model to generate structurally constrained, task-specific outputs that would be difficult to produce reliably with generic, context-free prompts. In one variation, the server executes the generative AI model locally, using a transformer architecture trained with backpropagation on a corpus of market-related texts. The server defines a loss function combining next-token prediction loss with structural constraint penalties that encourage the model to output bullet lists or specific section headers. During training, the server applies data augmentation by paraphrasing instruction sentences and by perturbing document texts, so that the model becomes robust to variations in user phrasing. The server stores model parameters and periodically retrains or fine-tunes the model using newly collected interaction data, thereby improving accuracy of summaries and proposals over time.

In another variation, the server uses a rule-based layer that post-processes the generative AI output. The server parses the generated text, checks for compliance with required structural conditions (for example, exactly three bullet points, presence of specified headings), and, if necessary, regenerates a modified prompt sentence that explicitly requests correction. This iterative prompt-control mechanism provides a non-conventional way of orchestrating the generative AI model, improving the reliability and predictability of outputs.

In still another variation, the server partitions the emotion-estimation process into sub-models for different modalities. The server maintains separate neural networks for text-based emotion estimation, facial-expression analysis, and audio-based emotion detection. The server fuses the outputs of these networks using a learned weighting scheme that optimizes prediction accuracy on labeled datasets. By using this modular and fused architecture, the server achieves a higher accuracy of emotional-state estimation than any single modality alone, which in turn leads to more appropriate adjustments of display data.

The described configurations and variations are not limited to the specific examples of hardware and software. The server can execute on any computing platform that provides sufficient processing capabilities, memory, storage, and network connectivity. The terminal can be any device with input and output capabilities and communication functions. The system architecture can be distributed across multiple servers or consolidated into a single machine, as long as the functional relationships and dataflows among the components are preserved.

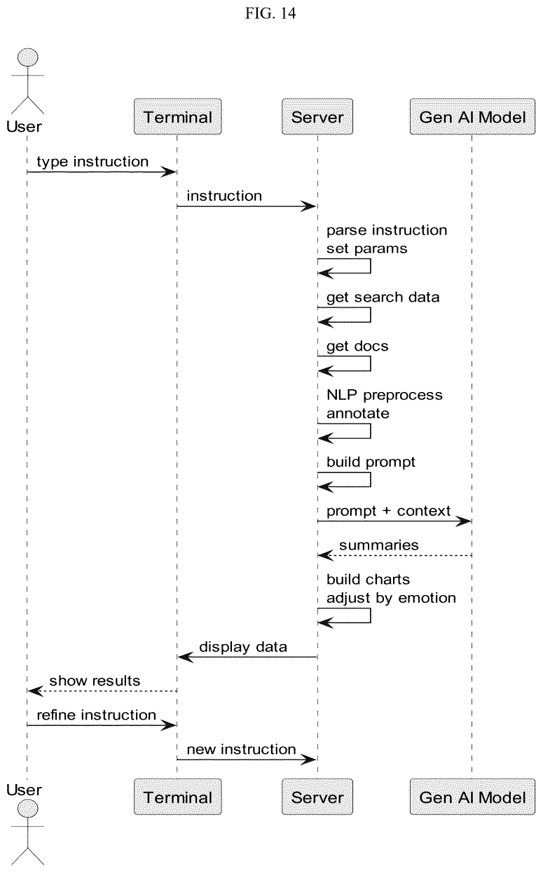

The following describes the processing flow using FIG. 14.

### Step 1

User inputs a natural-language instruction sentence on the terminal.
User types an instruction such as “Show me the latest competitor announcements about new products in the last two weeks and summarize them in three bullet points” into an input field.
Input: a natural-language string entered via keyboard or touch interface.
Terminal captures the string, attaches metadata such as user identifier and timestamp, and packages it into a request message.
Output: a structured request containing the instruction sentence and metadata, which the terminal prepares to send to the server.

### Step 2

Terminal transmits the user instruction to the server.
Terminal sends the request message to the server via a network connection using a communication protocol.
Input: the structured request including the natural-language instruction sentence and metadata.
Terminal encodes the message, establishes a secure channel if required, and issues a request to a predefined server endpoint.
Output: a network packet stream carrying the user instruction and metadata to the server.

### Step 3

Server receives and parses the instruction request.
Server accepts the incoming network message, verifies the format, and extracts the natural-language instruction sentence and associated metadata.
Input: the encoded request data from the terminal.
Server decodes the message, separates fields such as user identifier, time range hints, and raw text, and stores the raw text into a temporary buffer.
Output: an internal representation of the instruction, including a tokenizable instruction string and structured metadata.

### Step 4

Server analyzes the natural-language instruction sentence to determine analysis parameters.
Server tokenizes the instruction, applies syntactic and semantic parsing, and identifies target organizations, target period, requested operations, and output constraints.
Input: the internal instruction representation from Step 3.
Server performs data processing that includes part-of-speech tagging, entity recognition, and time-expression normalization to derive control variables such as “own organization,” “competing organizations,” “last 14 days,” and “summary in three bullet points.”
Output: a set of analysis parameters, including a list of target organizations, a time window, operation types (for example, “document collection,” “trend analysis,” “summary generation”), and output-format constraints.

### Step 5

Server acquires search information from search-information sources.
Server sends queries to one or more search-information sources to obtain search statistics for expressions related to the target organizations and topics.
Input: the analysis parameters from Step 4, particularly target expressions and time window.
Server constructs search queries, including expressions and date ranges, and issues requests to the search-information sources; upon receiving responses, server converts the responses into internal data structures such as time-series arrays indexed by time and search frequency.
Output: normalized search information records, each containing an expression, a time-series of values, and identifiers for an own organization or a competing organization.

### Step 6

Server aggregates and analyzes the search information.
Server processes the raw search information to produce aggregated, time-series, and statistical features.
Input: search information records from Step 5.
Server applies data operations such as resampling, averaging, and difference computation on the time-series arrays, and calculates derived metrics like moving averages and growth rates; server then labels each record with the relevant organization and time window.
Output: enriched search-analysis data, consisting of feature vectors and time-series structures ready for visualization and subsequent reasoning.

### Step 7

Server acquires document information from network-based information sources.
Server connects to network-based information sources, retrieves documents such as announcements or news articles, and filters them according to the analysis parameters.
Input: analysis parameters from Step 4, including target organizations, topics, and time window.
Server generates access requests for relevant URLs or APIs, receives documents in markup or structured formats, parses them to extract titles, publication dates, and main text, and converts the extracted contents into text records stored in a document repository.
Output: a collection of document information entries, each containing text content, metadata, and linkage to organizations and time periods.

### Step 8

Server pre-processes document information and search information by natural-language processing.
Server performs tokenization, lemmatization, stopword removal, entity recognition, topic detection, and sentiment estimation over document texts, and applies labeling or annotation to both document texts and associated search data.
Input: document information entries from Step 7 and search-analysis data from Step 6.
Server transforms text into token sequences and embedding vectors, tags entities such as product names and organization names, computes sentiment scores and topic labels, and associates these attributes with corresponding documents and search expressions; server also attaches target information indicating which entities each record relates to.
Output: annotated document records and annotated search records containing word-sequence information, emotion information, topic information, and target information.

### Step 9

Server generates a task-specific prompt sentence for the generative AI model.
Server constructs one or more prompt sentences that encode the user's request, the analysis parameters, and selected context extracted from pre-processed data.
Input: the analysis parameters from Step 4 and the annotated records from Step 8.
Server performs data selection and formatting operations, choosing representative documents or summaries of search trends, and concatenates them with an instruction template to form a coherent prompt sentence, such as “Summarize the following competitor announcements about new products in three bullet points, focusing on main features, target customers, and positioning: [document text].”
Output: a prompt sentence string and associated context data ready to be submitted to the generative AI model.

### Step 10

Server inputs the prompt sentence and context to the generative AI model and executes inference.
Server encodes the prompt sentence and any additional text or structured descriptions into token sequences and feeds them into the generative AI model to obtain generated outputs.
Input: the prompt sentence and context from Step 9.
Server converts characters into token identifiers, passes the tokens through the neural-network layers of the generative AI model, performs matrix multiplications and attention computations according to the model architecture, and decodes the resulting output token sequences into text strings that represent summary information, analysis information, integrated summary information, or proposal information.
Output: generated text outputs containing content such as bullet-point summaries, explanatory paragraphs, or structured recommendations.

### Step 11

Server constructs integrated summary information or strategy proposal information.
Server may combine multiple generated outputs into higher-level summaries or strategy proposals using additional generative AI calls or rule-based aggregation.
Input: individual generated outputs from Step 10 and analysis parameters indicating the need for integration.
Server merges content segments, removes redundancy using text similarity metrics, and, if required, forms another prompt sentence instructing the generative AI model to produce an overall summary describing trends; server then collects the integrated response and stores it as integrated summary information or proposal information.
Output: a consolidated set of textual outputs, including individual summaries and an integrated summary or proposal tailored to the user's instruction.

### Step 12

Server prepares visualization information and display data.
Server maps the generated text outputs and analysis data into graphical and layout structures suitable for presentation on the terminal.
Input: enriched search-analysis data from Step 6 and generated text outputs from Step 11.
Server generates chart configurations specifying axes, labels, and data series for representing search trends; server organizes textual summaries into lists or cards and associates each with links to underlying documents; server then packs these visual and textual components into a structured display data object.
Output: display data comprising visualization information and arranged text content ready for rendering on the terminal.

### Step 13

Server acquires multimodal user data for emotion estimation.
Server receives user action information, input information, image information, and audio information from the terminal and prepares these signals for emotion analysis.
Input: event logs, input text, image frames, and audio samples from the terminal.
Server aggregates behavior events into temporal sequences, extracts features such as scroll speed and dwell time, processes image frames to obtain facial-expression features, and processes audio signals to obtain pitch and energy features; server consolidates those features into a unified feature vector.
Output: a feature representation of the user's recent interaction suitable for input to an emotion classifier.

### Step 14

Server estimates the user's emotional state based on the multimodal features.
Server applies an emotion-classification model to the feature representation to obtain a predicted emotional state.
Input: the multimodal feature vector from Step 13.
Server propagates the feature vector through one or more neural-network layers, calculates activation values and class probabilities for emotional states, and selects the class with the highest probability as the predicted emotional state; server then associates this state with the corresponding user session.
Output: an emotional-state label or distribution representing the current emotional condition of the user.

### Step 15

Server adjusts content selection and presentation according to the emotional state.
Server modifies the display data by tuning the amount, ordering, and format of information in response to the predicted emotional state.
Input: the display data from Step 12 and the emotional-state label from Step 14.
Server applies adjustment rules or learned mappings, for example, reducing the number of visible summaries and highlighting key conclusions when the user is stressed, or expanding detailed analysis sections when the user appears highly interested; server then updates layout parameters and visibility flags within the display data.
Output: adjusted display data that encodes a personalized and emotion-aware presentation configuration.

### Step 16

Server transmits the adjusted display data to the terminal.
Server sends the updated layout and content to the terminal over the network.
Input: the adjusted display data from Step 15.
Server serializes the display data into a transmissible format, attaches response headers, and dispatches the response to the terminal endpoint associated with the user session.
Output: a response message carrying the adjusted display data to be rendered on the terminal.

### Step 17

Terminal renders the received display data for the user.
Terminal interprets the display data and renders charts, text summaries, and interactive elements on the display device.
Input: the response message containing adjusted display data from Step 16.
Terminal parses the visualization descriptors, calls graphical routines to draw charts representing search trends, inserts text summaries into defined containers, and configures interactive controls such as links and buttons; terminal then updates the user interface to show the new content.
Output: a visually updated interface presenting personalized summaries, analyses, and visualizations to the user.

### Step 18

User inspects the displayed information and may request further analysis.
User views the rendered summaries, charts, and proposals and interacts with the interface to open detailed documents or to issue new instructions.
Input: the displayed interface from Step 17.
User selects items of interest, follows links to full documents, and may type additional instruction sentences such as “Compare our product X with competitor Y's latest device and list advantages and disadvantages,” which the terminal captures as new input.
Output: new user actions and new natural-language instruction sentences that can initiate another iteration of the processing flow.

### Step 19

Server records interaction histories and updates adaptive models.
Server logs the user's instructions, browsing paths, actions, and estimated emotional states, and uses these logs to refine prompt-generation and presentation strategies.
Input: user interaction events from the terminal and emotional-state labels from Step 14.
Server stores each event into persistent storage with timestamps and context identifiers, then periodically runs learning procedures that adjust parameters of models used for prompt construction and layout selection, based on objective functions related to engagement and clarity; server thus updates its internal models to better match future user needs.
Output: updated model parameters and updated rules that influence future prompt sentences, analysis steps, and presentation configurations.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

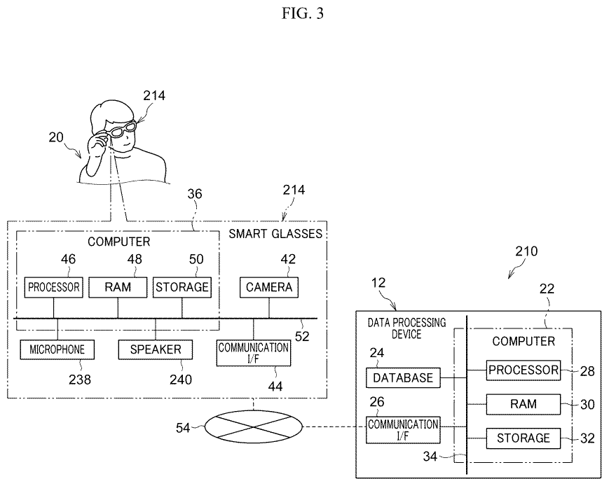

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

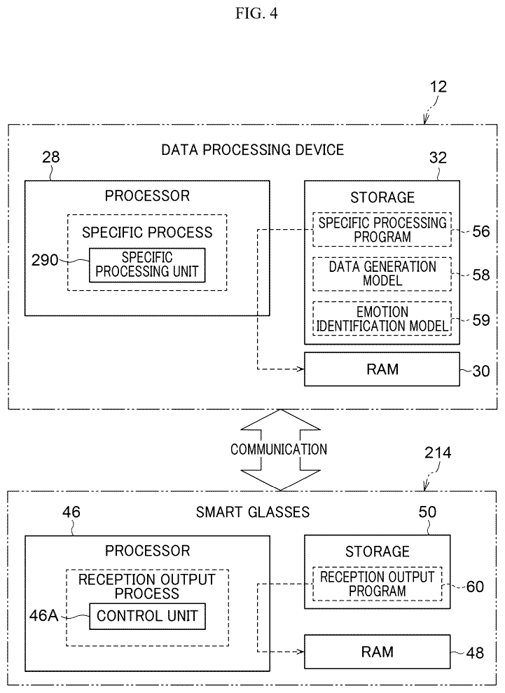

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

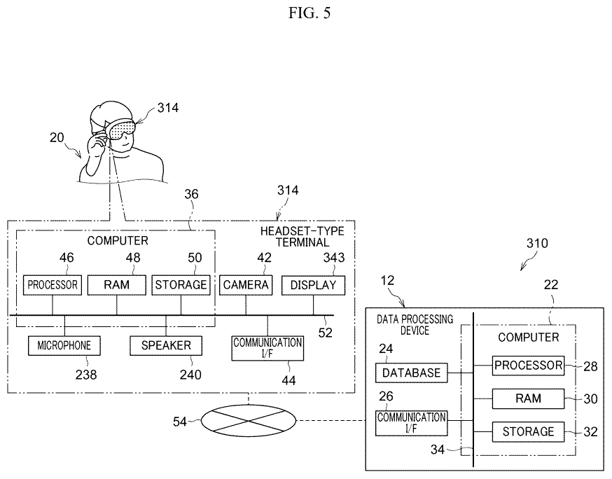

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

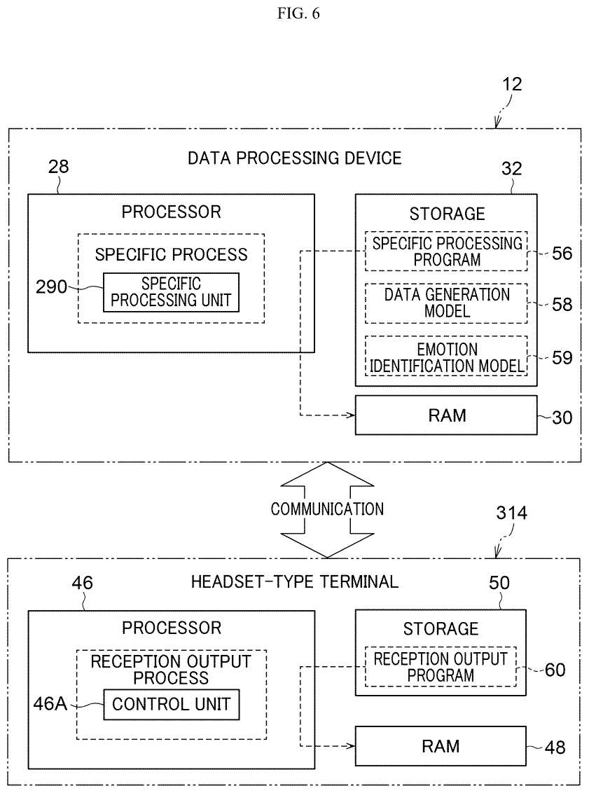

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

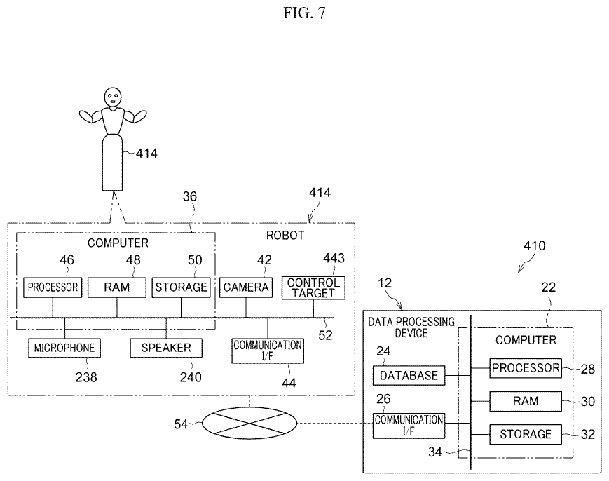

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

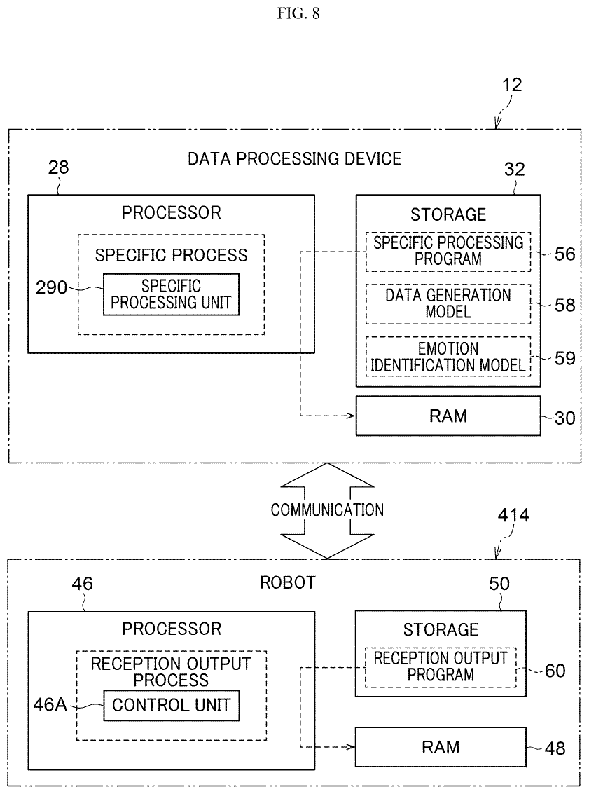

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

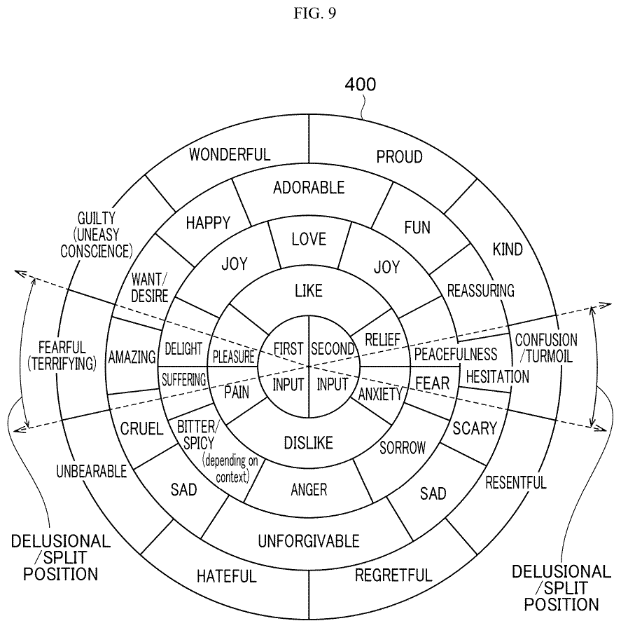

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

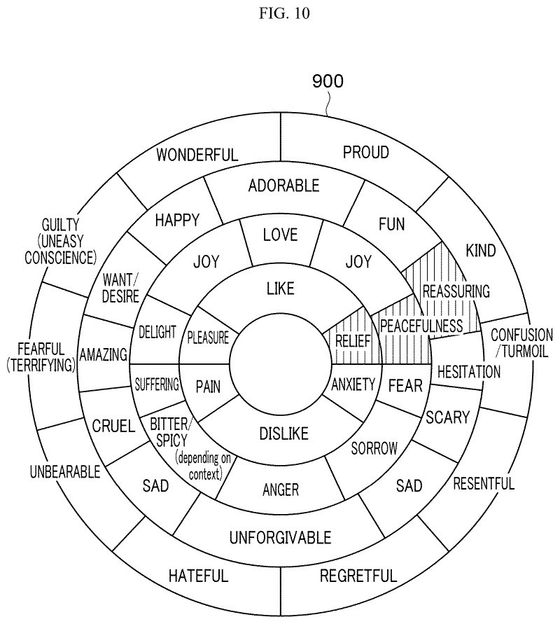

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
acquire, via a communication function, information including search data from an information providing apparatus, convert the acquired information into structured tabular data based on time information and area information, and calculate indices representing search frequency, relative search ratios, and trend transitions from the structured tabular data, convert, based on the calculated indices, comparative results of search trends relating to a plurality of search terms into visualization data that can be visually displayed, and generate display control information for interactively displaying the visualization data on a display apparatus,
generate a prompt sentence including content summarizing analysis results containing the calculated indices and the comparative results, and instructions for a generation policy of an explanation, input the prompt sentence to a generative information processing model, and obtain from the generative information processing model an explanation text to be associated with the analysis results and output,
receive, from a user, input including search terms, period information, and area information, receive additional conditions from the user who has viewed the explanation text and the visualization data, and control acquisition of the information from the information providing apparatus and regeneration of the analysis results based on the additional conditions, and
transmit information including the explanation text and the visualization data to the display apparatus, and cause the display apparatus to display the visualization data in such a manner that the user can operate the visualization data and confirm detailed information.

### Supplementary 2

The system according to supplementary 1,
wherein the processor is configured to
analyze input information and operation history of a user to estimate a state of the user, and adjust a presentation format of the analysis results by changing content of the prompt sentence and a level of detail or an expression format of the explanation text obtained from the generative information processing model in accordance with the estimated state of the user.

### Supplementary 3

The system according to supplementary 1,
wherein the processor is configured to
transmit, to the display apparatus, screen configuration information including information adjusted based on the state of the user together with the explanation text and the visualization data, and cause the display apparatus to emphasize-display or selectively display the adjusted information.

### Application Example 1

### Supplementary 1

A system comprising a processor,
wherein the processor is configured to
collect, store, aggregate, and statistically process search history information acquired from a search service via an information acquisition medium so as to grasp an occurrence state of search terms related to a predetermined entity and entities competing with the predetermined entity within a predetermined period, and to generate trend information for each search term by calculating at least a time-series variation amount and a growth rate for each search term, generate, on the basis of the trend information and advertising distribution conditions, an input text including analysis results for optimization of candidate search terms for advertising distribution, input the input text as a prompt sentence to a generative information processing model, and acquire, from the generative information processing model, response information including groups of advertising search terms classified by at least one of user attribute and user intent and explanation information related to the groups of advertising search terms, and analyze the groups of advertising search terms included in the response information, generate evaluation information for each advertising search term by associating the groups of advertising search terms with statistical information based on the search history information, and transmit the groups of advertising search terms and the evaluation information to a display control unit so as to cause an output device to display the groups of advertising search terms and the evaluation information in a form allowing a user to reflect the groups of advertising search terms and the evaluation information in an advertising distribution setting.

### Supplementary 2

The system according to supplementary 1,
wherein the processor is configured to
analyze input information and operation history information acquired from the user so as to estimate an emotional state of the user, and adjust at least one of presentation content and presentation order of an analysis result of the search history information and the response information acquired from the generative information processing model in accordance with the emotional state.

### Supplementary 3

The system according to supplementary 1,
wherein the processor is configured to
transmit adjusted presentation content to the display control unit so as to cause the output device to display the adjusted presentation content to the user.

### Example 2

### Supplementary 1

A system comprising a processor,
wherein the processor is configured to
collect, aggregate, and analyze search history information of a search service acquired via a communication network, in order to understand which search terms are used to search for a specified business entity and a competing business entity within a predetermined period, obtain location information of public information sources related to the competing business entity on the basis of information source management data, acquire structured document data from the public information sources according to the location information, and automatically extract text data corresponding to notification information from the structured document data, perform document preprocessing on the text data to generate preprocessed text data by executing data processing including removal of unnecessary information, normalization of character types, and division of long text into a plurality of segments,
generate a prompt sentence including instruction content for summarizing the preprocessed text data, input the prompt sentence and the preprocessed text data to a generative artificial intelligence model, and cause the generative artificial intelligence model to output summary text data so as to generate a summary of the text data,
perform postprocessing on the summary text data to generate summary record data by executing processing including length adjustment, deletion of duplicate sentences, and addition of classification information, and associating attribute information including a competing business entity name, a publication time, and an information type with the summary text data, and storing the summary record data in a storage device, and
acquire the summary record data via a display control interface, generate visualization data by arranging the summary record data in chronological order or by category on the basis of the attribute information, and transmit the visualization data to a display device so that the visualization data is visually displayed on a user terminal and a user can confirm the summary text data in a list form.

### Supplementary 2

The system according to supplementary 1,
wherein the processor is configured to
analyze user input information and user behavior history information to estimate an emotional state of the user, and dynamically change the visualization data by adjusting at least one of a display order, an emphasis degree, and a presentation target of the summary record data, on the basis of the estimated emotional state and an analysis result of the search history information.

### Supplementary 3

The system according to supplementary 1,
wherein the processor is configured to
transmit the dynamically changed visualization data to the display device, and cause the display device to provide adjusted information to the user by performing at least one of emphasized display and filtered display of the summary text data and corresponding attribute information selected according to the emotional state of the user.

### Application Example 2

### Supplementary 1

A system comprising a processor,
wherein the processor is configured to
acquire information from network-based information sources and search-information sources, extract document information related to a predetermined target from the acquired information and store the document information as text information,
acquire search information from an internet search source and analyze the search information as aggregated information, time-series information, and statistical information in order to recognize, within a specified period, expressions by which an own organization and a competing organization are searched,
receive a natural-language instruction sentence or inquiry sentence input by a user, and analyze the instruction sentence or the inquiry sentence to identify required information sources, a target period, a target organization, and a processing content,
pre-process the acquired document information and the analyzed search information by natural-language processing to extract sequence-of-word information, emotion information, topic information, and target information,
generate a prompt sentence for a generative AI model so as to instruct the generative AI model to generate summary information or analysis information based on the document information and the search information, and input the prompt sentence and at least one of the document information and the search information to the generative AI model to obtain the summary information or the analysis information as an output,
control the generative AI model to generate integrated summary information or proposal information of a strategy by inputting a plurality of pieces of the summary information to the generative AI model so as to describe an overall trend,
convert the summary information, the analysis information, and the integrated summary information into display data together with visualization information indicating a search trend and visualization information indicating a trend of the competing organization, and output the display data to a display device,
acquire, from a user terminal, user action information, input information, image information, and audio information, and estimate an emotional state of the user based on the action information, the input information, the image information, and the audio information, adjust contents, level of detail, priority, and presentation format of the summary information, the analysis information, and the display data in accordance with the estimated emotional state,
transmit adjusted display data to the user terminal and cause the adjusted display data to be presented in a form that the user can easily confirm,
reconstruct an additional natural-language instruction sentence from the user as a prompt sentence to be input to the generative AI model, and cause the generative AI model to generate comparison information, evaluation information, or proposal information in accordance with the additional natural-language instruction sentence, and
record a history of instructions, a browsing history, an action history, and an emotional-state history of the user, and update, in a learning manner, a generation method of the prompt sentence and a generation method of the display data based on the record.

### Supplementary 2

The system according to supplementary 1,
wherein the processor is configured to
cause a user terminal to acquire a natural-language instruction sentence of the user via an input interface, transmit the instruction sentence to the system via a communication path, and visually present, as graph information, list information, and notification information, the summary information, the analysis information, and the integrated summary information received from the system, and further transmit operation information, gaze-like information, pointer-movement information, and viewing-time information of the user to the system so as to support estimation of the emotional state of the user and adjustment of information presentation.

### Supplementary 3

The system according to supplementary 1,
wherein the processor is configured to
dynamically generate the prompt sentence to be input to the generative AI model based on contents of the natural-language instruction sentence of the user, an analysis result of the search information, the topic information and the emotion information of the document information, and the emotional state of the user, and include, in the prompt sentence, condition descriptions regarding a summary target, a summary format, an output structure, a focus point, and an output amount, thereby obtaining, from the generative AI model, summary information and proposal information optimized for business-strategy planning.

What is claimed is:

1. A system comprising:
circuitry configured to:
receive, via a communication interface coupled to a packet-switched network, information including search data from one or more information providing apparatus, convert the received information into structured tabular data based on time information and area information, and calculate indices representing at least search frequency, relative search ratios, and trend transitions for a plurality of search terms;
generate a prompt sentence incorporating at least the structured tabular data and competitor-published information, input the prompt sentence to a generative AI model to obtain a summary of competitor information, and generate visual display data presenting the summary; and
transmit the visual display data to a terminal device via the communication interface.

2. The system according to claim 1, wherein the circuitry is configured to collect and analyze search data from an information search tool to determine, for a specified period, search terms associated with a specified entity and a comparison entity, and incorporate the determined search terms into the structured tabular data.

3. The system according to claim 2, wherein the circuitry is configured to calculate trend transition data from the structured tabular data, and generate a prompt sentence incorporating the trend transition data and an instruction for the generative AI model to generate a summary analysis of the search trends.

4. The system according to claim 3, wherein the circuitry is configured to acquire competitor-published information from an external information source via the communication interface, incorporate the competitor-published information into the prompt sentence, and receive from the generative AI model a summary of the competitor-published information.

5. The system according to claim 4, wherein the circuitry is configured to generate the visual display data by combining the summary output from the generative AI model with the trend transition data, and format the visual display data for presentation on the terminal device.

6. The system according to claim 1, wherein the circuitry is configured to analyze input data or behavioral data of the user received from the terminal device via the communication interface to recognize an emotional state of the user, and adjust the visual display data based on the recognized emotional state.

7. The system according to claim 6, wherein the circuitry is configured to adjust at least one of a data emphasis, a presentation format, and a content depth of the visual display data based on the recognized emotional state of the user.

8. The system according to claim 1, wherein the circuitry is configured to periodically acquire updated search data and competitor-published information via the communication interface, recalculate the search indices, regenerate the prompt sentence for the generative AI model, and update the summary transmitted to the terminal device.

9. The system according to claim 8, wherein the circuitry is configured to detect changes in the search indices between successive updates, generate a prompt sentence instructing the generative AI model to analyze the detected changes, and incorporate the change analysis into the visual display data.

10. The system according to claim 1, wherein the circuitry is configured to receive, from the terminal device via the communication interface, a specification of a time period and a geographic area, and filter the structured tabular data based on the specified time period and geographic area prior to generating the prompt sentence.

11. The system according to claim 10, wherein the circuitry is configured to recalculate the search indices based on the filtered tabular data, and generate a geographically and temporally specific summary for transmission to the terminal device.

12. The system according to claim 1, wherein the circuitry is configured to receive user context information from the terminal device via the communication interface including at least an industry category and a business objective, and incorporate the user context information into the prompt sentence to personalize the summary generated by the generative AI model.

13. The system according to claim 12, wherein the circuitry is configured to adjust the ranking of competitor-related information in the summary based on relevance to the user context information, and present the adjusted ranking in the visual display data.

14. The system according to claim 1, wherein the circuitry is configured to generate a second prompt sentence incorporating a comparison between the search indices for the specified entity and the comparison entity, input the second prompt sentence to the generative AI model, and obtain a comparative analysis for inclusion in the visual display data.

15. The system according to claim 14, wherein the circuitry is configured to generate visualization elements representing the comparative analysis as a graphical overlay in the visual display data, and transmit the visual display data including the graphical overlay to the terminal device.

16. The system according to claim 1, wherein the circuitry is configured to store the structured tabular data, prompt sentences, and generated summaries in a storage device in association with time-stamped records, and retrieve stored records for historical trend analysis.

17. The system according to claim 16, wherein the circuitry is configured to generate a prompt sentence incorporating historical records retrieved from the storage device, input the prompt sentence to the generative AI model to obtain a trend analysis over a specified historical period, and transmit the trend analysis to the terminal device.

18. A system comprising:
circuitry configured to:
receive, via a communication interface coupled to a packet-switched network, search data from one or more information providing apparatus, convert the search data into structured tabular data, and calculate search frequency indices and trend transitions for a plurality of search terms;
acquire competitor-published information via the communication interface, generate a prompt sentence incorporating the structured tabular data and the competitor-published information, and input the prompt sentence to a generative AI model to obtain a summary;
recognize an emotional state of a user based on data received from a terminal device via the communication interface, and adjust the summary based on the recognized emotional state; and
generate visual display data from the adjusted summary and transmit the visual display data to the terminal device via the communication interface.

19. The system according to claim 18, wherein the circuitry is configured to receive user context information from the terminal device including an industry category and a business objective, incorporate the user context information into the prompt sentence, and personalize the summary generated by the generative AI model based on the user context information.

20. A method comprising:
receiving, via a communication interface coupled to a packet-switched network, information including search data from one or more information providing apparatus, converting the received information into structured tabular data, and calculating indices representing search frequency, relative search ratios, and trend transitions;
generating a prompt sentence incorporating the structured tabular data and competitor-published information, inputting the prompt sentence to a generative AI model to obtain a summary, and generating visual display data presenting the summary; and
transmitting the visual display data to a terminal device via the communication interface.
